(19) United States
(12) Patent Application Publication
(10) Pub. No.: US 2017/0083468 A1
(43) Pub. Date: Mar. 23, 2017

(54) IDENTIFYING MULTIPLE IDENTICAL DEVICES ON A SHARED BUS

(71) Applicant: QUALCOMM Incorporated, San Diego, CA (US)

(72) Inventor: Shoichiro Sengoku, San Diego, CA (US)

(21) Appl. No.: 14/860,609

(22) Filed: Sep. 21, 2015

(51) Int. Cl. G06F 13/364; G06F 13/40; G06F 13/42

(52) U.S. Cl. CPC G06F 13/364; G06F 13/4282; G06F 13/404

(57) ABSTRACT

A self-identification system is provided for slave devices that share a bus with a plurality of other identical slave devices. Each slave device may include two or more additional interfaces (e.g., single line), distinct from the shared bus, and coupled to at least one adjacent slave device. A protocol known to the master and slave devices is used to allow each slave device to identify itself without the need to explicitly transmit a unique identifier between the master device and the slave devices. The plurality of slave devices are daisy chained via the first and second interfaces, which are selectively driven and/or weakly pulled up or down in response to one or more broadcasts from the master device. Based on the state of their first and second interface, a slave device may respond to a broadcast and thus implicitly provides an identifier to the master device.

### FIELD

The present disclosure pertains to operating multiple identical devices on a shared bus and, more particularly, to auto-identification techniques that allow a master device coupled to the shared bus to uniquely identify each of the multiple identical devices on the shared bus.

### BACKGROUND

In some systems, such as camera systems, it would be beneficial to use multiple identical devices on a shared bus. However, a way is needed to distinguish the multiple identical devices from each other when addressed on the bus.

One approach to uniquely identifying devices may be to configure each device with a unique or fixed identifier during manufacturing. However, such approach adds costs and an extra step to the manufacturing process so it is undesirable.

A second approach to providing identifiers to devices may be to have a master device that controls the shared bus assign random identifiers to each device coupled to the shared bus. However, due to the use of random identifiers this approach has the risk of more than one device ending up with the same identifier.

Therefore, a way is needed for identical devices, coupled to a shared bus, to obtain unique identifiers during operation (i.e., not fixed during manufacturing).

### SUMMARY

A first aspect provides a master device, comprising a shared bus interface and a processing circuit coupled the shared bus interface. The processing circuit configured to: (a) send a first broadcast over the shared bus to which a plurality of identical slave devices are coupled, the first broadcast initiating self-identification of one or more of the plurality of identical slave devices, (b) receive a reply over the shared bus from a slave device, in response to the first broadcast, indicating that a slave device has self-identified, and/or (c) continue to send one or more broadcasts over the shared bus, to uniquely identify each of the plurality of identical slave devices, until all slave devices in the plurality of identical slave devices have self-identified. Subsequently, the processing circuit may send a communication over the shared bus specifically addressed to a first slave device using a corresponding first identifier, in a slave device list, associated with the first slave device. A unique identifier for each of the plurality of identical slave devices is not explicitly provided to each slave device by the device. For instance, a unique identifier for each slave device in the plurality of identical slave devices is not preconfigured into the slave devices. Additionally, the reply may implicitly indicate a unique identifier for the replying slave device but does not include the identifier.

In one implementation, the device may know all slave devices have been identified when no reply is received to a broadcast over the shared bus. In another implementation, the device may have prior knowledge of a total number of the plurality of identical slave devices coupled to the shared bus, and the device stops sending the one or more broadcasts once that total number of the plurality of identical slave devices have been uniquely identified.

In one example, the first broadcast indicates to the plurality of identical slave devices to identify a first slave device in a daisy chain of slave devices.

In yet another example, each of the one or more broadcasts may be distinct from each other and implies a unique slave device identifier.

In yet another example, each of the one or more broadcasts may be the same and does not imply a unique slave device identifier.

In some implementations, a single broadcast may result in two replies from two different slave devices, and each of the two different slave devices is associated with a different unique slave device identifier based on the order in which the replies are received.

A second aspect provides slave device comprising a shared bus interface, a first interface and a second interface, distinct from the shared bus interface, and a processing circuit coupled to the shared bus interface, the first interface, and the second interface. The processing circuit may be configured to: (a) receive a broadcast over a shared bus interface, (b) drive the first interface based on the broadcast and whether or not the slave device has a current identifier, (c) sense the second interface for a change of state from a default state, (d) ascertain, based on a state of the second interface and the slave device lacking a current identifier, that the slave device should self-identify, (e) associate a unique identifier, implied by the broadcast or discerned from information obtained from an adjacent slave device, with the slave device, and/or (f) reply to the broadcast over the shared bus with an acknowledgement.

A third aspect provides a device comprising a shared bus, a master device, and one or more slave devices. The master device may be coupled to the shared bus and configured to control communications over the shared bus. The one or more slave devices may be identical to each other and are coupled to the shared bus. Each slave device may include a first interface and a second interface distinct from the shared bus. Where more than one slave device is present, each slave device is coupled to at least one other slave device over the first and/or second interface;

The master device is configured to uniquely identify each of the plurality of slave devices by: (a) sending a first broadcast over the shared bus, (b) receiving a reply from a responding slave device indicating that a slave device has self-identified, (c) identify the responding slave device with a unique identifier, and/or (d) continuing to send additional broadcasts over the shared bus and receiving additional replies from different slave devices until all slave devices in the plurality of slave devices have self-identified.

Upon receipt of the first broadcast, each slave device is further configured to: (a) drive the first interface to cause the second interface of another slave device to be driven to a different state than its default state; and (b) sense the second interface to ascertain whether its default state has been changed by an adjacent slave device. Only a first slave device whose second interface is not driven sends a reply over the shared bus. Each additional slave device sends a reply in response to additional broadcasts on the shared bus depending on whether its second interface is driven or not, where slave devices that have already been identified drive or floats their first interface.

### DRAWINGS

Various features, nature, and advantages may become apparent from the detailed description set forth below when taken in conjunction with the drawings in which like reference characters identify correspondingly throughout.

FIG. 1 is a block diagram illustrating an exemplary apparatus in which identical devices coupled to a shared bus 104 may obtain unique identifiers using a self-identification process.

FIG. 2 is a block diagram illustrating an exemplary apparatus having a baseband processor and an image sensor and implementing an image data bus and a multi-mode control data bus.

FIG. 3 (comprising FIGS. 3A and 3B) illustrates a self-identification process that may be implemented to uniquely identify a plurality of identical slave devices coupled to a shared bus.

FIG. 4 is a flow diagram illustrating an exemplary method that may be implemented between a master device and a plurality of slave devices coupled to a shared bus to permit the slave devices to self-identify.

FIG. 5 illustrates a first exemplary arrangement of identical slave devices in a daisy chained (in series) configuration.

FIG. 6 illustrates a second exemplary arrangement of identical slave devices in a daisy chained (in series) configuration.

FIG. 7 illustrates a third exemplary arrangement of identical slave devices in a daisy chained (in series) configuration.

FIG. 8 illustrates a fourth exemplary arrangement of identical slave devices in a daisy chained (in series) configuration.

FIG. 9 illustrates an exemplary arrangement of two types of slave devices coupled in series in a daisy chained configuration.

FIG. 10 illustrates an exemplary arrangement of two types of slave devices coupled in separate daisy chain configurations.

FIG. 11 (comprising FIGS. 11A, 11B, and 11C) illustrates another exemplary self-identification process that may be implemented to uniquely identify a plurality of identical slave devices coupled to a shared bus.

FIG. 12 is a flow diagram illustrating an exemplary method that may be implemented between a master device and a plurality of slave devices coupled to a shared bus to permit the slave devices to self-identify.

FIG. 13 (comprising FIGS. 13A and 13B) illustrates a bi-directional self-identification process that may be implemented to uniquely identify a plurality of identical slave devices coupled to a shared bus.

FIG. 14 is a flow diagram illustrating an exemplary method that may be implemented between a master device and a plurality of identical slave devices coupled to a shared bus to permit the slave devices to self-identify.

FIG. 15 illustrates a grid array configuration of a plurality of identical slave devices, where each slave device has four interfaces separate from a shared bus interface.

FIG. 16 (comprising FIGS. 16A, 16B, and 16C) illustrates a first part of a unidirectional scan process that allows a plurality of identical slave devices in a two dimensional array and coupled to a shared bus to self-identify to a master device on the shared bus.

FIG. 17 (comprising FIGS. 17A, 17B, and 17C) illustrates a second part of a unidirectional scan process that allows a plurality of identical slave devices in a two dimensional array and coupled to a shared bus to self-identify to a master device on the shared bus.

FIG. 18 illustrates a first part of a bidirectional scan process that allows a plurality of identical slave devices in a two dimensional array and coupled to a shared bus to self-identify to a master device on the shared bus.

FIG. 19 illustrates a second part of a bidirectional scan process that allows a plurality of identical slave devices in a two dimensional array and coupled to a shared bus to self-identify to a master device on the shared bus.

FIG. 20 (comprising FIGS. 20A and 20B) illustrates another unidirectional scan process that allows a plurality of identical slave devices in a two dimensional array and coupled to a shared bus to self-identify to a master device on the shared bus.

FIG. 21 illustrates another grid array configuration of a plurality of identical slave devices, where each slave device has four contactless interfaces separate from a shared bus interface.

FIG. 22 is a block diagram illustrating an exemplary master device that may be configured to facilitate self-identification of a plurality of identical devices on a shared bus.

FIG. 23 illustrates a method that may be operational on a master device to facilitate self-identification by one or more identical slave devices.

FIG. 24 is a block diagram illustrating an exemplary slave device that may be configured to self-identify and distinguish itself from a plurality of identical devices coupled to a shared bus.

FIG. 25 illustrates a method that may be operational on a slave device to self-identify.

### DETAILED DESCRIPTION

In the following description, specific details are given to provide a thorough understanding of the embodiments. However, it will be understood by one of ordinary skill in the art that the embodiments may be practiced without these specific detail. For example, circuits may be shown in block diagrams in order not to obscure the embodiments in unnecessary detail. In other instances, well-known circuits, structures, and techniques may not be shown in detail in order not to obscure the embodiments.

Various features, nature, and advantages may become apparent from the detailed description set forth below when taken in conjunction with the drawings in which like reference characters identify correspondingly throughout.

### Overview

A first aspect provides for a way for a master device to distinguish between a plurality of identical slave devices coupled to a shared bus without the need for explicitly transmitting slave device identifiers over the shared bus.

A second aspect provides for a slave device to self-identify and distinguish itself from a plurality of identical slave devices which are all coupled to a shared bus. The slave device are not assigned a particular identifier by the master device nor do they include a preconfigured unique identifier. Instead, the slave device is coupled to other slave devices via a first and second interfaces which are distinct from the shared bus. The first and second interfaces are selectively driven (asserted) or sensed (unasserted) based on a received broadcast from the master device and also based on whether the slave device has already self-identified.

A third aspect provides for arranging a plurality of slave devices in a daisy chain configuration, where each slave device is configured to selectively drive (assert) or sense (deassert) its first interface and/or second interface in response to one or more broadcasts over the shared bus to permit each slave device to self-identify. In self-identifying, each slave device may associate itself with a unique, self-assigned identifier; not an identifier assigned by the master device or pre-configured into each slave device.

A fourth aspect provides for arranging a plurality of slave devices in a grid configuration, where each slave device is configured to selectively drive (assert) or sense (deassert) its first interface, a second, interface, a third interface, and/or a fourth interface in response to one or more broadcasts over the shared bus to permit each slave device to self-identify. In self-identifying, each slave device may associate itself with a unique, self-assigned identifier; not an identifier assigned by the master device or pre-configured into each slave device.

### Exemplary Operating Environment

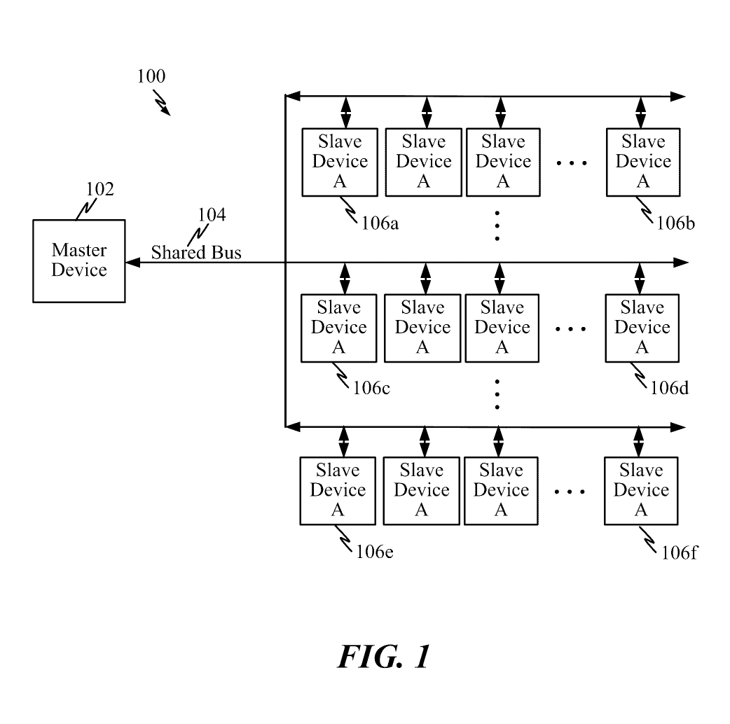

FIG. 1 is a block diagram illustrating an exemplary apparatus 100 in which identical devices coupled to a shared bus 104 may obtain unique identifiers using a self-identification process. The apparatus 100 may include, for example, a master device 102 which controls communications over the shared bus 104 (e.g., a two-line bus) to which a plurality of identical slave devices 106 are coupled. In one example, the slave devices 106 may communicate over the shared bus 104 only when permitted and/or instructed by the master device 102. In order address each individual slave device 106, the master device 102 has to uniquely identify each slave device 106. However, the slave devices 106 may be identical and/or not provisioned with a unique and/or fixed identifier beforehand (e.g., during manufacturing or a post-manufacturing stage).

The master device 102 and slave devices 106 may be configured to implement a self-identification or identifier allocation process during an initialization stage (e.g., when the device 100 is powered on or reset). This self-identification or identifier allocation process may allow each slave device 106 to identify itself to the master device 102, thereby allowing the master device to uniquely address each slave device. This may be done without the master device 102 explicitly assigning an address to each slave device 106 and without each of the slave devices being pre-provisioned with a unique identifier.

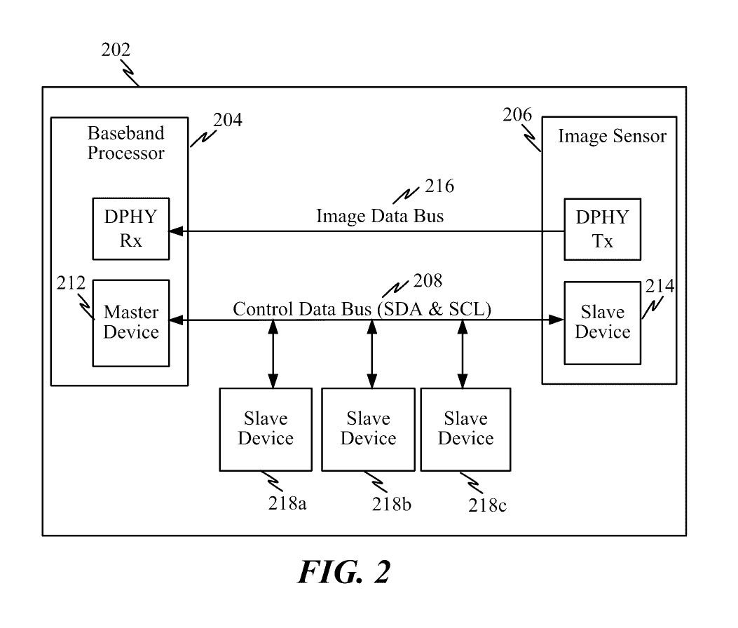

FIG. 2 is a block diagram illustrating an exemplary apparatus 202 having a baseband processor 204 and an image sensor 206 and implementing an image data bus 216 and a multi-mode control data bus 208. The apparatus 202 in FIG. 2 may be one exemplary implementation of the apparatus 102 of FIG. 1. While FIG. 2 illustrates the multi-mode control data bus 208 within a camera device, it should be clear that this control data bus 208 may be implemented in various different devices and/or systems. Image data may be sent from the image sensor 206 to the baseband processor 204 over the image data bus 216 (e.g., a high speed differential DPHY link). In one example, the control data bus 208 may be an I2C-compatible bus comprising two wires, i.e., a clock line (SCL) and a serial data line (SDA). The clock line SCL may be used to synchronize all data transfers over the I2C bus (control data bus 108). The data line SDA and clock line SCL may be coupled to all devices 212, 214, and 218 on the control data bus 208. In this example, control data may be exchanged between the baseband processor 204 and the image sensor 206 as well as other peripheral (slave) devices 218 via the control data bus 208. In some implementations, the operating modes over the control data bus 208 may be referred to as a camera control interface (CCI) mode when used for camera applications. In other examples, the control data bus 208 may include one wire or more than two wires.

As used herein the terms “device identifier”, “slave device identifier” and “SID” may be interchangeably used to refer to a unique identifier for a slave device coupled to a shared bus.

### First Exemplary Approach for Self-Identification of Slave Devices Coupled to a Shared Bus

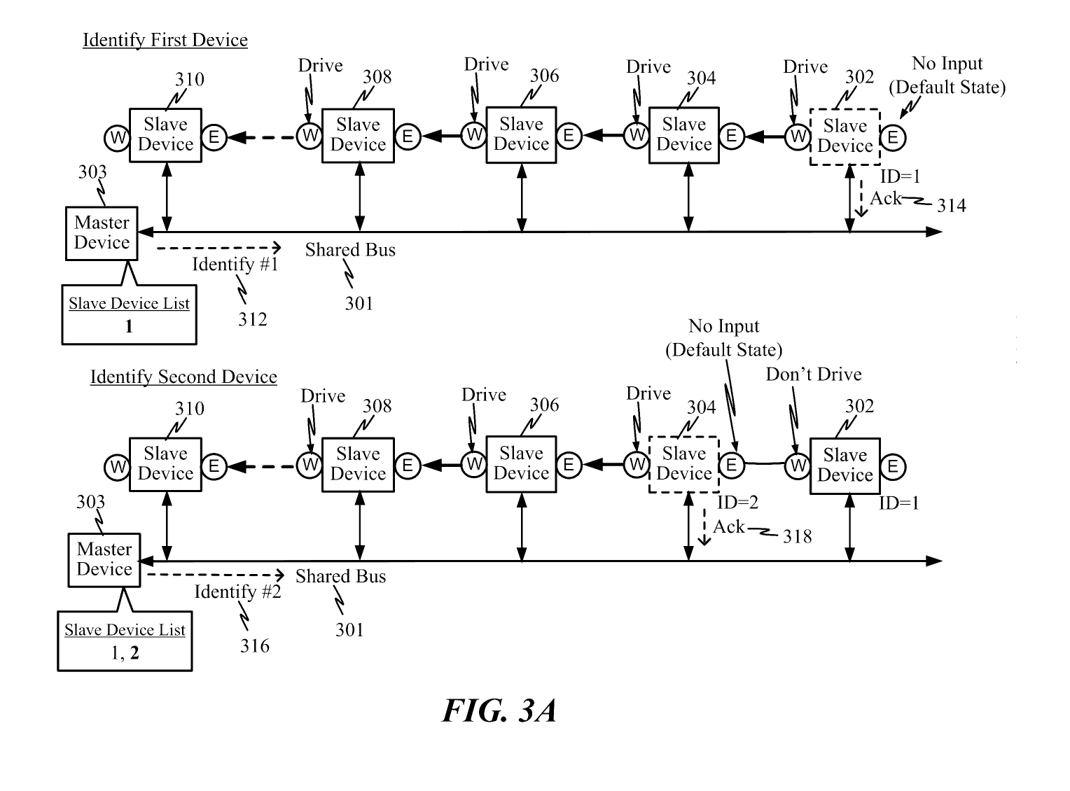

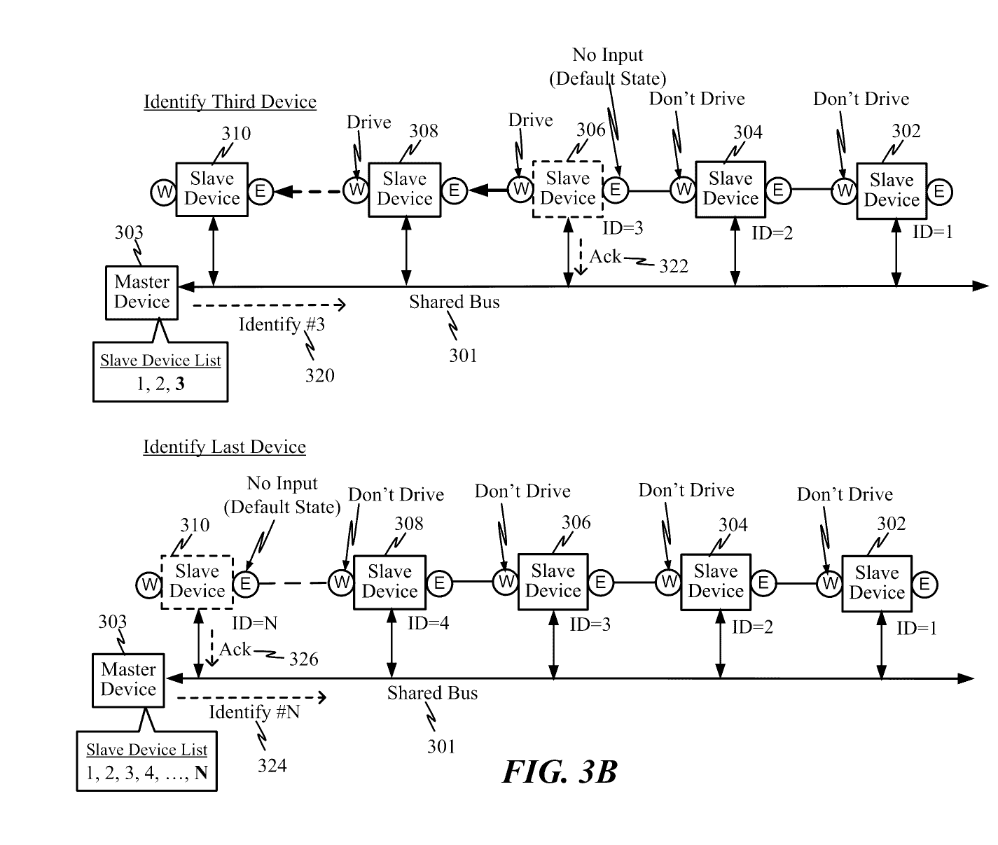

FIG. 3 (comprising FIGS. 3A and 3B) illustrates a self-identification process that may be implemented to uniquely identify a plurality of identical slave devices 302, 304, 306, 308, and 310 coupled to a shared bus 301. Note that a master device 303 is also coupled to the shared bus 301 and serves to control communications over the shared bus 301.

Each slave device 302, 304, 306, 308, and 310 may include a shared bus interface, which is used to couple to the shared bus 301, and two interfaces (labeled as “E” and “W”), which are used by the slave devices 302, 304, 306, 308, and 310 for the self-identification process. Each of the “E” and “W” interfaces may be single line interfaces. In some implementations, each of the “W” and “E” interfaces may be unidirectional interfaces. In one example, a unidirectional interface is one which can either be driven (e.g., to a high or low state) by its slave device or senses a change of its default state (i.e., the sensing interface may be weakly pulled up or down but can be driven by another slave device from its default state), but not both. In the example, illustrated in FIG. 3, the “W” interfaces may serve to drive an adjacent “E” interface of a different slave device. Meanwhile, the “E” interfaces may merely sense if their state is being changed from a default state.

The plurality of slave devices 302, 304, 306, 308, and 310 may be daisy chained (e.g., coupled in series, or coupled in a chain) to each other using these two interfaces, with the “W” interface for a first device coupled to the “E” interface for a second device. Consequently, except for the first and last device in the chain, each slave device in the chain has its “W” interface and “E” interface coupled to another slave device. In one example, the “E” interface is weakly pulled to a default state by the slave device (e.g., pulled up or pulled down by a circuit internal to the slave device). The “W” interface of each slave device may be selectively driven high or low (i.e., not floating) opposite the default state of the “E” interface. In one example, none of the slave devices in the daisy chain is coupled to the master device via the “W” interface or the “E” interface.

In response to one or more broadcasts/commands over the shared bus, the slave devices may be configured to self-identify and distinguish itself from a plurality of identical slave devices which are all coupled to a shared bus. The slave devices are not assigned a particular identifier by the master device nor do they include a preconfigured unique identifier. Instead, the slave device is coupled to other slave devices via their first interface (“E” interface) and second interface (“W” interface). The first and second interfaces are selectively driven (asserted) or sensed based on a received broadcast from the master device and also based on whether the slave device has already self-identified. In self-identifying, each slave device may associate itself with a unique, self-assigned identifier; not an identifier assigned by the master device or pre-configured into each slave device.

Initially, the master device 303 may send an “Identify #1” broadcast 312 over the shared bus 301. For instance, such “Identify #1” broadcast 312 may be sent upon power-up or boot up of a device that includes the master device 303, the shared bus 301, and/or the slave devices 302, 304, 306, 308, and 310. At this point, upon receipt of such broadcast or command, all slave devices 302, 304, 306, 308, and 310 drive their “W” interface to a state opposite the default state for the “E” interface. For instance, the “W” interface of a first slave device 302 may be selectively driven (e.g., high or low) to set or pull the “E” interface of a second slave device to a state (e.g., high or low) opposite to the default state. Consequently, when a broadcast/command is received over the shared bus 301, each slave device knows whether it is coupled to another slave device by virtue of the state of its “E” interface changing or not changing from a default state.

Only a first slave device 302 (i.e., the device whose “E” interface is not driven or changed from its default state) in the daisy chain of slave devices responds with an “acknowledge” (Ack) 314 over the shared bus 301. From this point forward, that responding first slave device 302 is identified as #1 over the shared bus 301 by both the master device 303 and the first slave device 302. None of the other slave devices respond to the “Identify #1” broadcast 312.

Next, the master device 303 sends an “Identify #2” broadcast 316 over the shared bus 301. Since the first slave device 302 has already been identified as #1, it knows not to respond to the “Identify #2” broadcast 316 and also knows not to drive its “W” interface (e.g., it may simply float or drive its “W” interface to an opposite state). A second slave device 304, whose “E” interface is no longer driven, responds to the “Identify #2” broadcast by sending an acknowledge 318. From this point forward, that responding second slave device 304 may be identified as #2 by the master device 303 over the shared bus 301. None of the other slave devices 302, 306, 308, and 310 respond to the “Identify #2” broadcast 316.

Next, the master device 303 sends an “Identify #3” broadcast 320 over the shared bus 301. Since the first slave device 302 and second slave device 304 have already been identified as #1 and #2, respectively, they know not to respond to the “Identify #3” broadcast 320. Since the first slave device 302 and second slave device 304 already have an identifier, they also know not to drive their “W” interfaces (e.g., their W interfaces may simply float or is driven to an opposite state). A third slave device 306, whose “E” interface is no longer driven, responds to the “Identify #3” broadcast 320 by sending an acknowledge 322. From this point forward, that responding third slave device 306 may be identified as #3 by the master device 303 over the shared bus 301. None of the other slave devices 302, 304, 308, and 310 respond to the “Identify #3” broadcast 320.

Note that, in this approach, the number of unique identify messages/commands/broadcasts (e.g., “Identify #1”, “Identify #2”, “Identify #3, etc.) defined or available in the protocol used between the master device 303 and slave devices 302, 304, 306, 308 and 310 should be sufficient to accommodate the number slave devices coupled to the shared bus.

This process continues until all slave devices on the shared bus have been identified. For instance, the master device 303 sends an “Identify #N” broadcast 324 over the shared bus 301. Since all other slave device have already been identified, they know not to respond to the “Identify #N” broadcast 324. Consequently, all other slave devices know not to drive their “W” interfaces. A last slave device 310, whose “E” interface is no longer driven, responds to the “Identify #N” broadcast 324 by sending an acknowledge 326.

In implementations where the master device 303 has prior knowledge of the total number of slave devices available beforehand (e.g., through prior configuration), the process of identifying slave devices may stop once the number of identified slave devices has been reached.

However, in implementations in which the master device 303 does not know the total number of slave devices beforehand, the master device 303 may send a “Identify #N+1” broadcast to which no slave device responds because all slave devices have been identified (this assumes there are N slave devices on the shared bus 301). Since the master device 303 does not receive an “acknowledge” to the “Identify #N+1” broadcast, it knows all slave devices on the shared bus 301 have been identified.

In an alternative approach, in order to avoid the cost associated with pull-up or pull-down resistors for the default state, the use of a weak pull-up or pull-down at an interface may be avoided. Instead, all slave devices may drive/assert their “W” interfaces to a first state (e.g., logic High or Low) while no “Identify” broadcast/command is issued. When an “Identify” broadcast/command is sent over the shared bus 301, slave devices that are already (previously) identified maintain their “W” interfaces driven/asserted to the first logic state while unidentified slave devices drive/assert their “W” interfaces to a second logic state (i.e., opposite/distinct from the first logic state) for a predefined period (e.g., such period may be defined by a protocol used).

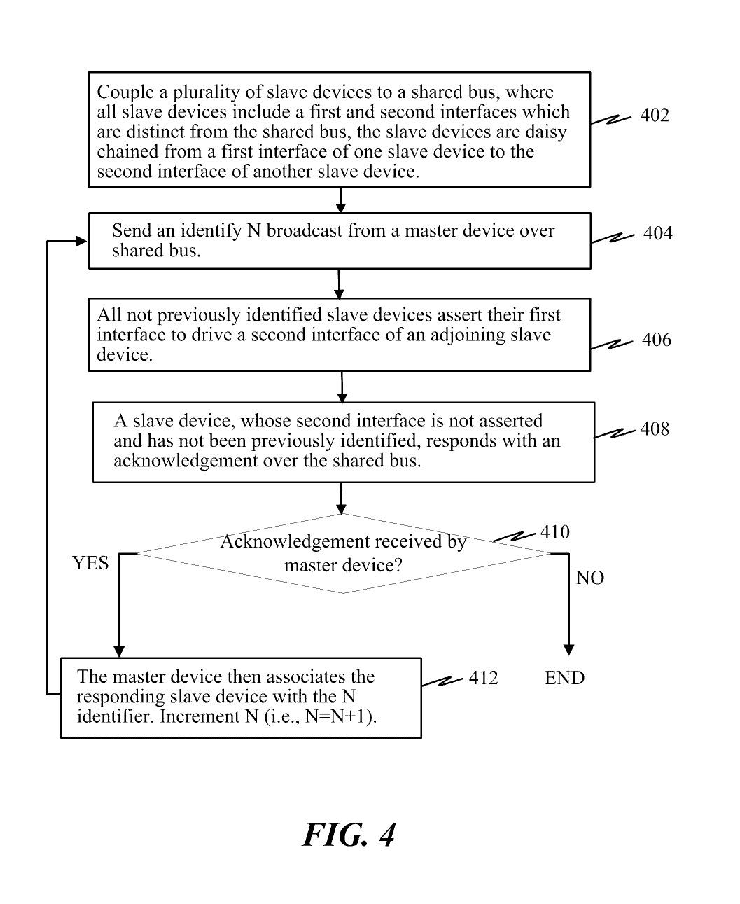

FIG. 4 is a flow diagram illustrating an exemplary method that may be implemented between a master device and a plurality of slave devices coupled to a shared bus to permit the slave devices to self-identify. An example of this method is illustrated in FIG. 3. The plurality of slave devices may be coupled to the shared bus, where all slave devices include a first and second interfaces (e.g., “W” interface and “E” interface of FIG. 3) which are distinct from the shared bus, the slave devices are daisy chained from a first interface of one slave device to the second interface of another slave device 402. The master device may send an identify N broadcast from over shared bus 404 (e.g., during a boot-up or initialization stage). As previously illustrated in FIG. 3, all previously unidentified slave devices assert/drive their first interface (e.g., “W” interface) to cause a second interface (e.g., “E” interface) of an adjoining slave device 406 to change from a default state (e.g., change to a state opposite the default state). A slave device, whose second interface (“E” interface) is not asserted and has not been previously identified, responds with an acknowledgement over the shared bus 408. If any of the slave devices responds, an acknowledgement is received by the master device 410. The master device then associates the responding slave device with the N identifier and/or may increment the slave device count (i.e., N=N+1) 412. This process continues until no acknowledgement is received from the slave devices (i.e., all slave devices have been identified).

In an alternative implementation, the master device may have prior knowledge of the total number of slave devices coupled to the shared bus. Consequently, step 412 may be modified so that the master device simply stops sending identify N broadcasts when the last acknowledgement is received (e.g., once the total number of received acknowledgements equal the number of slave devices).

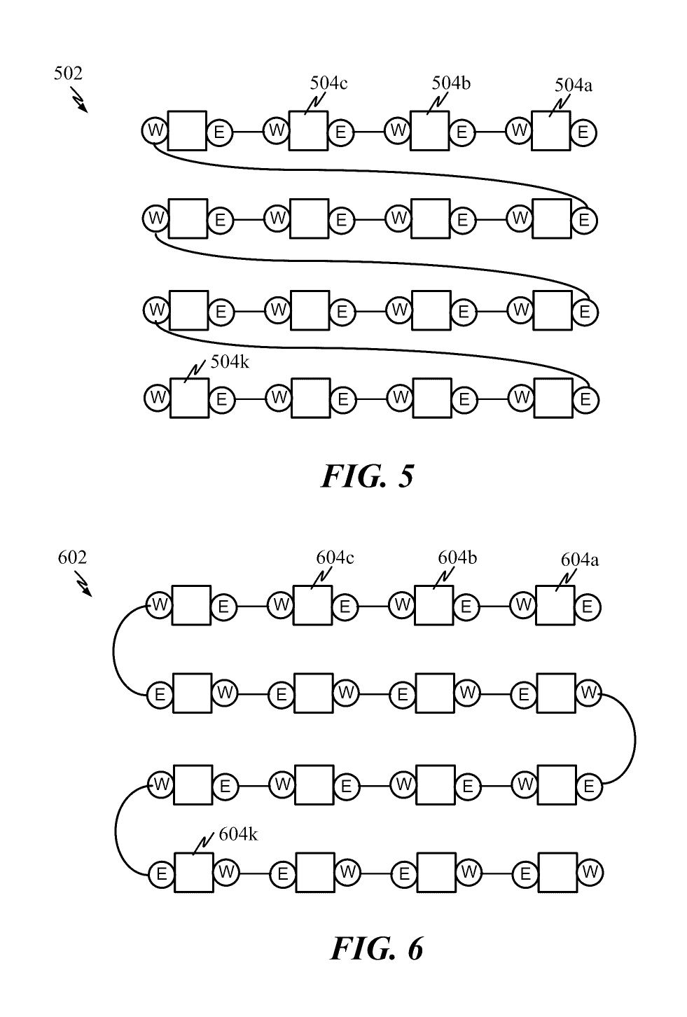

FIG. 5 illustrates a first exemplary arrangement 502 of identical slave devices 504 in a daisy chained (in series) configuration. For instance, the slave devices may be optical sensors for a digital camera and may be arranged in a grid pattern. This figure illustrates how the first interface (the “W” interface) and second interface (“E” interface) for each slave device in a grid of slave devices 504 may be electrically coupled.

FIG. 6 illustrates a second exemplary arrangement 602 of identical slave devices 604 in a daisy chained (in series) configuration. For instance, the slave devices may be optical sensors for a digital camera and may be arranged in a grid pattern. This figure illustrates how the first interface (the “W” interface) and second interface (“E” interface) for each slave device in a grid of slave devices 604 may be electrically coupled.

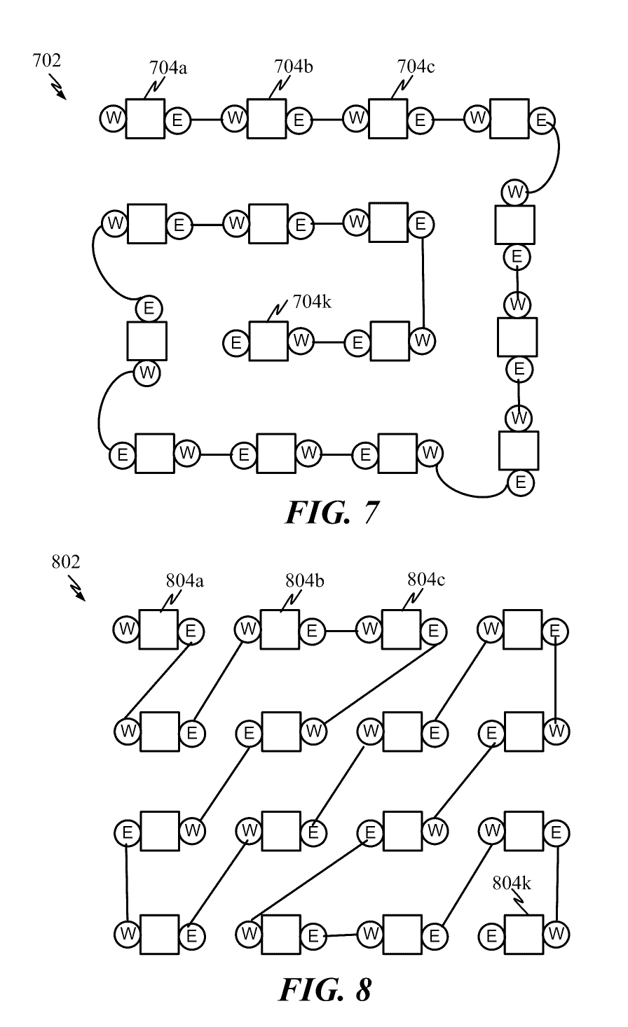

FIG. 7 illustrates a third exemplary arrangement 702 of identical slave devices 704 in a daisy chained (in series) configuration. For instance, the slave devices may be optical sensors for a digital camera and may be arranged in a grid pattern. This figure illustrates how the first interface (the “W” interface) and second interface (“E” interface) for each slave device in a grid of slave devices 704 may be electrically coupled.

FIG. 8 illustrates a fourth exemplary arrangement 802 of identical slave devices 804 in a daisy chained (in series) configuration. For instance, the slave devices may be optical sensors for a digital camera and may be arranged in a grid pattern. This figure illustrates how the first interface (the “W” interface) and second interface (“E” interface) for each slave device in a grid of slave devices 804 may be electrically coupled.

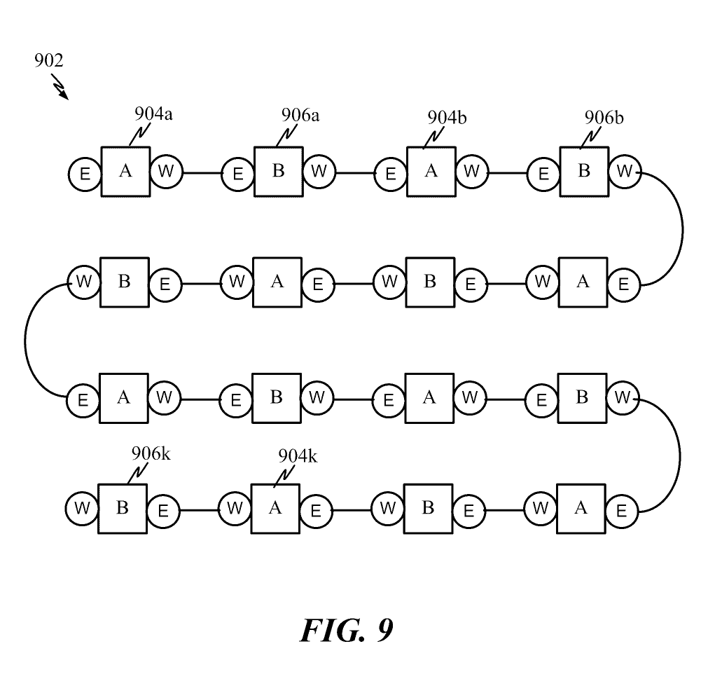

FIG. 9 illustrates an exemplary arrangement 902 of two types of slave devices 904 and 906 coupled in series in a daisy chained configuration. For instance, the two types of slave devices 904 and 906 may be different types of optical sensors for a digital camera and may be arranged in a grid pattern. This figure illustrates how the first interface (the “W” interface) and second interface (“E” interface) for each slave device in a grid of slave devices 904 and 906 may be electrically coupled. In this example, the distinct types of slave devices are coupled in a single chain.

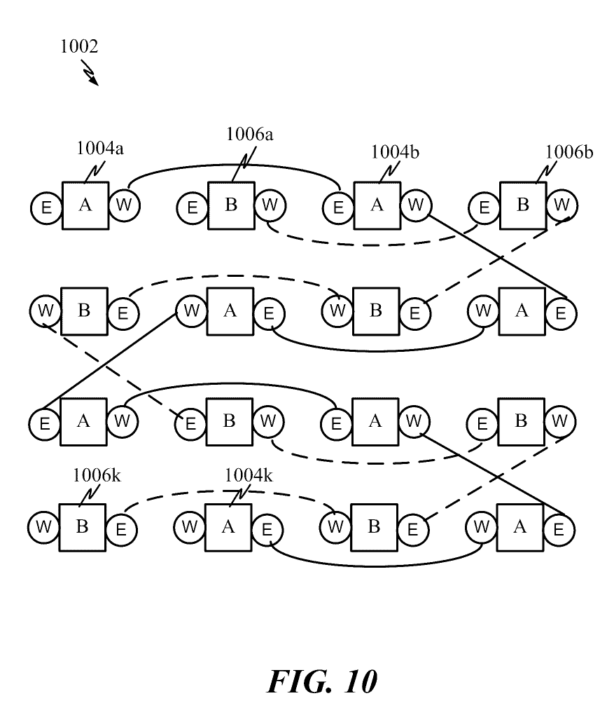

FIG. 10 illustrates an exemplary arrangement 1002 of two types of slave devices 1004 and 1006 coupled in separate daisy chain configurations. For instance, the two types of slave devices 1004 and 1006 may be different types of optical sensors for a digital camera and may be arranged in a grid pattern. This figure illustrates how the first interface (the “W” interface) and second interface (“E” interface) for each slave device in a first type of slave devices 1004 may be electrically coupled. Similarly, the first interface (the “W” interface) and second interface (“E” interface) for each slave device in a second type of slave devices 1006 may be electrically coupled. In this example, the distinct types of slave devices are coupled in a separate chains.

In yet other alternative implementations, the “W” interface and/or “E” interface may be contactless interfaces, such are a short-range radio transmitter and radio receiver, and a light emitting diode and/or light sensor. Consequently, the slave devices may be communicatively coupled to each other via their “W” interfaces and “E” interfaces.

### Second Exemplary Approach for Self-Identification of Slave Devices Coupled to a Shared Bus

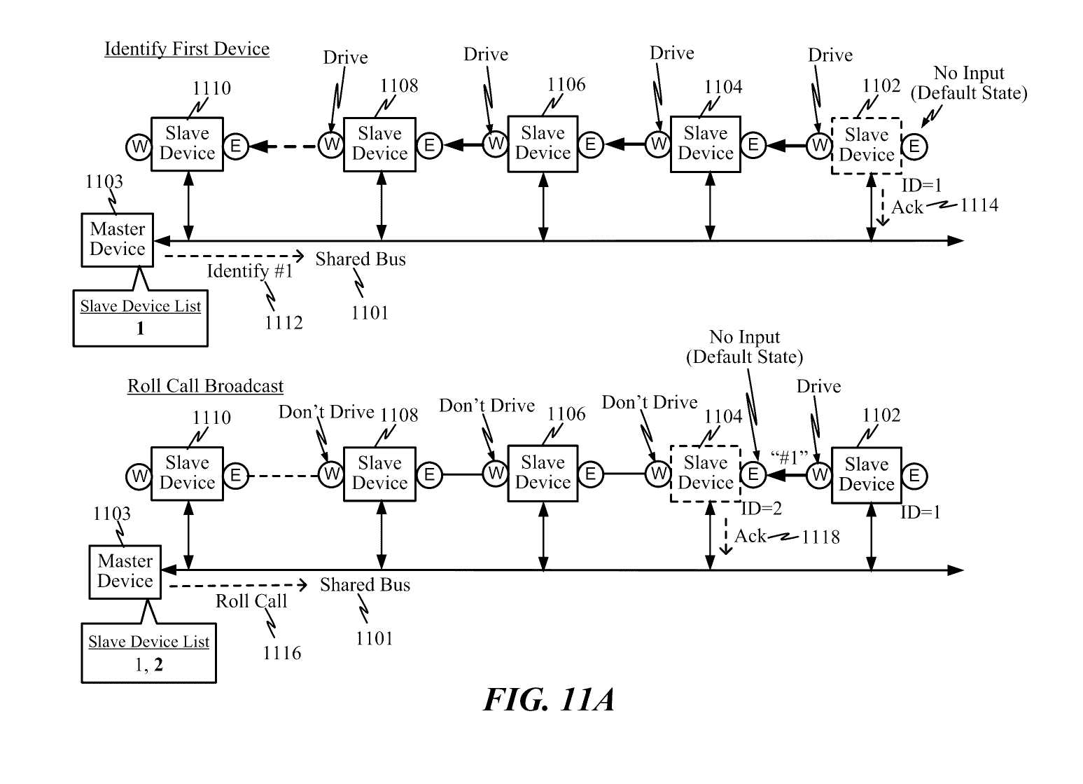

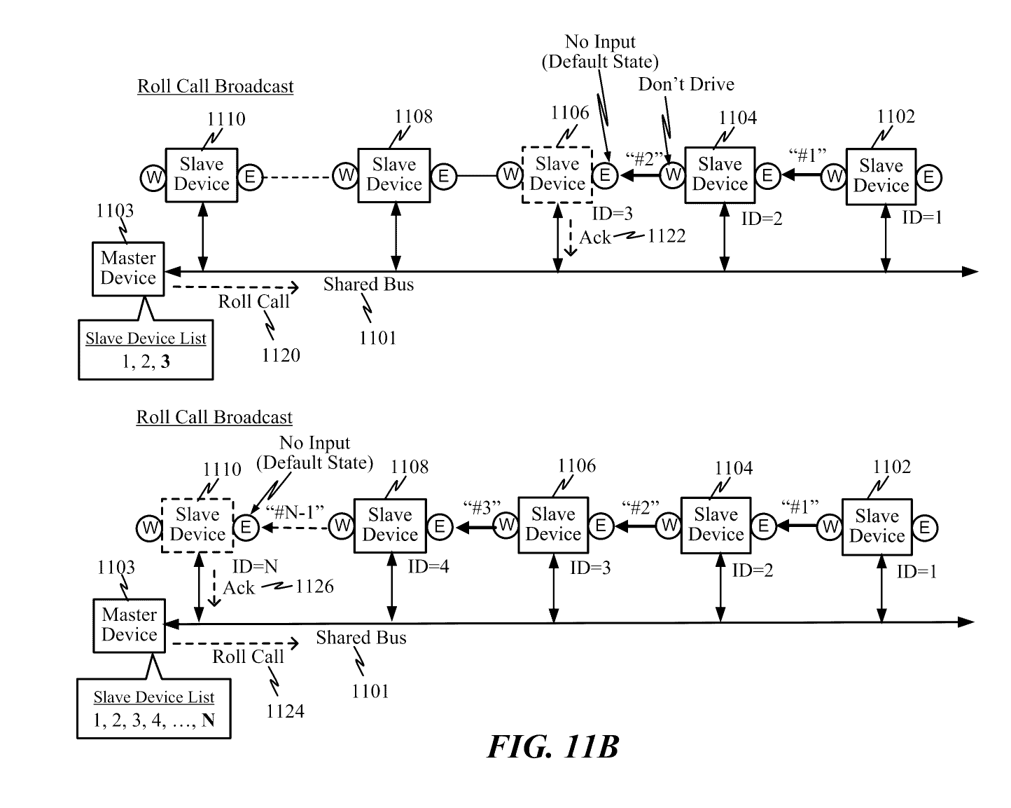

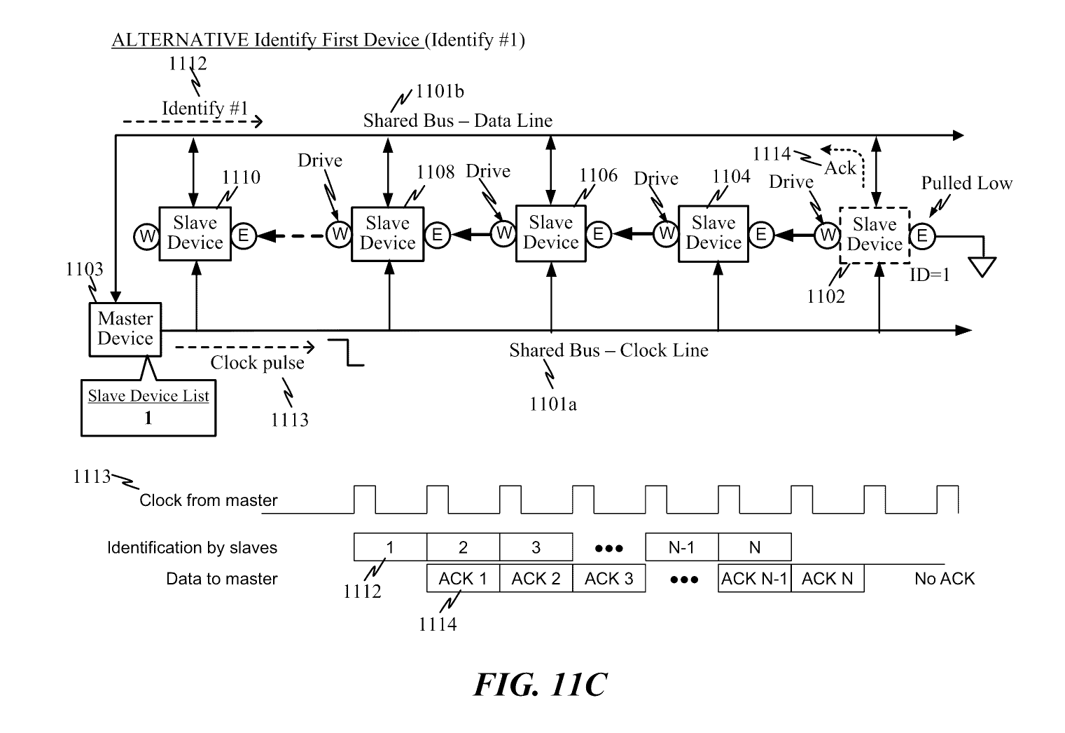

FIG. 11 (comprising FIGS. 11A and 11B) illustrates another exemplary self-identification process that may be implemented to uniquely identify a plurality of identical slave devices 1102, 1104, 1106, 1108, and 1110 coupled to a shared bus 1101. Note that a master device 1103 is also coupled to the shared bus 1101 and serves to control communications over the shared bus 1101. The approach illustrated in FIG. 11 may be an alternative to the approach illustrated in FIG. 3.

Note that, in the first approach illustrated in FIG. 3, a relatively large number of unique identify messages/command/broadcasts (e.g., “Identify #1”, “Identify #2”, “Identify #3, etc.) are needed in the protocol used between the master device 303 and slave devices 302, 304, 306, 308 and 310. Such large number of unique identify messages/command/broadcasts may be undesirable as it may slow down the performance of the self-identification process.

An alternative approach is provided herein that uses fewer distinct or unique messages, commands, and/or broadcasts to accomplish self-identification of slave devices coupled to a shared bus. In this approach, a first identify command/broadcast is used to identify a first slave device in a daisy chain of slave devices and one or more instances of a roll call command/broadcast is used to identify all other slave devices in the daisy chain. Use of the roll call command/broadcast may be simpler, smaller, and therefore faster; one command can be as simple as single clock pulse.

Each slave device 1102, 1104, 1106, 1108, and 1110 may include a bus interface, which is used to couple to the shared bus 1101, and two interfaces (labeled as “E” and “W”), which are used by the slave devices 1102, 1104, 1106, 1108, and 1110 for the self-identification process. The plurality of slave devices 1102, 1104, 1106, 1108, and 1110 may be daisy chained (e.g., coupled in series, or coupled in a chain) to each other using these two interfaces, with the “W” interface for a first device coupled to the “E” interface for a second device. Consequently, except for the first and last device in the chain, each slave device in the chain has its “W” interface and “E” interface coupled to another slave device. In one example, none of the slave devices in the daisy chain is coupled to the master device via the “W” interface or the “E” interface.

In one example, each of the “E” interfaces and “W” interfaces may be unidirectional interfaces. A unidirectional interface may be used to communicate and/or receive information in one direction. In one example, a unidirectional interface may either be driven (e.g., to a high or low state) by its slave device or can sense a change from its default state (i.e., the sensing interface may be weakly pulled up or down but can be driven by another slave device from its default state), but not both.

In an exemplary first mode of operation, illustrated in FIG. 11—Identify First Device, the “W” interfaces may serve to drive an adjacent “E” interface of a different slave device. Meanwhile, the “E” interfaces may sense if their state is being changed from a default state.

In an exemplary second mode of operation, illustrated in FIG. 11—Roll Call Broadcast, the “W” interfaces may operate as a serial communication bus to transmit information to an adjacent “E” interface which is adapted to receive such serial communication. For instance, in one exemplary implementation, such serial communication between a “W” interface and an “E” interface may use a clock signal from the shared bus 1101, thereby allowing transmission of information (e.g., a device identifier) over the single line between the “W” and “E” interfaces. In another exemplary implementation, such serial communication between a “W” interface and an “E” interface may use an internal clock counter. One example of a version of this approach is illustrated in FIG. 11C, where the clock line 1101a of the shared bus is used by the slave devices to trigger acknowledge replies over the shared bus data line 1101b. Note that the first slave device 1102 may have its “E” interface pulled low, which overcomes the internal weak pull-up of the “E” interface and denotes the first slave device 1102 as being the first slave device in the daisy chain of slave devices.

Initially, the master device 1103 may send an “Identify #1” broadcast 1112 over the shared bus 1101. For instance, such “Identify #1” broadcast 1112 may be sent upon power-up or boot up of a device that includes the master device 1103, the shared bus 1101, and/or the slave devices 1102, 1104, 1106, 1108, and 1110. At this point, all slave devices 1102, 1104, 1106, 1108, and 1110 drive their “W” interface.

In one example, the “Identify #1” broadcast 1112 triggers the first mode of operation in the slave devices. In this first mode, the “E” interface may be weakly pulled to a default state (e.g., pulled up or pulled down) by the slave device. The “W” interface of each slave device may be selectively driven high or low (i.e., not floating) opposite the default state of the “E” interface. Therefore, the “W” interface of a first slave device may be selectively driven (e.g., high or low) to set or pull the “E” interface of a second slave device to a state (e.g., high or low) opposite the default state. Consequently, by virtue of the state of its “E” interface, each slave device knows whether it is coupled to another slave device.

Only a first slave device 1102 (i.e., the device whose “E” interface is not driven) in the daisy chain of slave devices responds with an “acknowledge” (Ack) 1114 over the shared bus 1101. The first slave device 1102 also self-identifies with the identifier #1 from this point forward (e.g., until a power cycle or reset). The master device, having received the “acknowledge” (Ack) 1114 over the shared bus, implicitly knows to add identifier #1 to its slave device list. From this point forward, that responding first slave device 1102 is identified as #1 over the shared bus 1101 by both the master device 1103 and the first slave device 1102. None of the other slave devices respond to the “Identify #1” broadcast 1112.

Next, the master device 1103 sends a “Roll Call” broadcast 1116 over the shared bus 1101. In one example, the “Roll Call Identify #1” broadcast 1112 triggers the second mode of operation in the slave devices. In this second mode, the slave device(s) that have been previously identified (e.g., those slave devices that have sent an acknowledgement in reply to an identifier or roll call broadcast) provide their identifier (via their “W” interface) to an adjacent slave device that receives it via their “E” interface. Since the first slave device 1102 has already been identified as #1, it knows to serially send its identifier via its “W” interface and not respond to the Roll Call broadcast 1116. Since none of the other slave devices 1104, 1106, 1108, and 1110 have been identified yet, they know not to send any information or drive their “W” interfaces (e.g., these may simply float) in response to the Roll Call broadcast. The “E” interface of a second slave device 1104 receives identifier #1 from the first slave device 1102. Consequently, the second slave device 1104 assigns itself identifier #2 (e.g., increments the received identifier) and responds to the Roll Call broadcast by sending an acknowledgement 1118. From this point forward, that responding second slave device 1104 may be identified as #2 by the master device 1103 over the shared bus 1101. Note that the master device 1103 knows that the second slave device 1104 is associated with identifier #2 because the only other identifier in its list is currently #1. None of the other slave devices 1102, 1106, 1108, and 1110 respond to the “Roll Call” broadcast 1116.

Next, the master device 1103 sends another “Roll Call” broadcast 1120 over the shared bus 1101. Since the first slave device 1102 and second slave device 1104 have already been identified as #1 and #2, respectively, they know to send their respective identifiers over their “W” interfaces but not to respond (i.e., send an acknowledgement over the shared bus 1101) to the Roll Call broadcast 1120. Since none of the other slave devices 1106, 1108, and 1110 have been identified yet, they know not to drive their “W” interfaces (e.g., these may simply float) in response to the Roll Call broadcast 1120. The “E” interface of a third slave device 1106 receives identifier #2 from the second slave device 1104. Consequently, the third slave device 1106 assigns itself identifier #3 (e.g., increments the received identifier) and responds to the Roll Call broadcast by sending an acknowledgement 1122. From this point forward, that responding third slave device 1106 may be identified as #3 by the master device 1103 over the shared bus 1101. Note that the master device 1103 knows that the third slave device 1106 is associated with identifier #3 because the previous identifier in its list is currently #2. None of the other slave devices 1102, 1104, 1108, and 1110 respond to the “Roll Call” broadcast 1120.

This process continues until all slave devices on the shared bus have been identified. For instance, the master device 1103 sends another “Roll Call” broadcast 1124 over the shared bus 1101. With the exception of a last slave device 1110, all other slave devices 1102, 1104, 1106 and 1108 have already been identified and they know to send their respective identifiers over their “W” interfaces but not to respond (i.e., send an acknowledgement over the shared bus 1101) to the Roll Call broadcast 1124. The last slave device 1110, receives the identifier #N−1 from the previous slave device via its “E” interface. Consequently, the last slave device 1110 assigns itself identifier #N and responds to the Roll Call broadcast 1124 by sending an acknowledgement 1126. From this point forward, that responding last slave device 1110 may be identified as #N by the master device 1103 over the shared bus 1101. Note that the master device 1103 knows that the last slave device 1110 is associated with identifier #N because the previous identifier in its list is currently #N−1. None of the other slave devices 1102, 1104, 1106, and 1108, respond to the “Roll Call” broadcast 1124.

Note that the master device may send a final “Roll Call” broadcast to which no slave device responds because all slave devices have been identified (this assumes there are N slave devices on the shared bus 1101). Since the master device 1103 does not receive an “acknowledge” to the last “Roll Call” broadcast, it knows all slave devices on the shared bus 1101 have been identified.

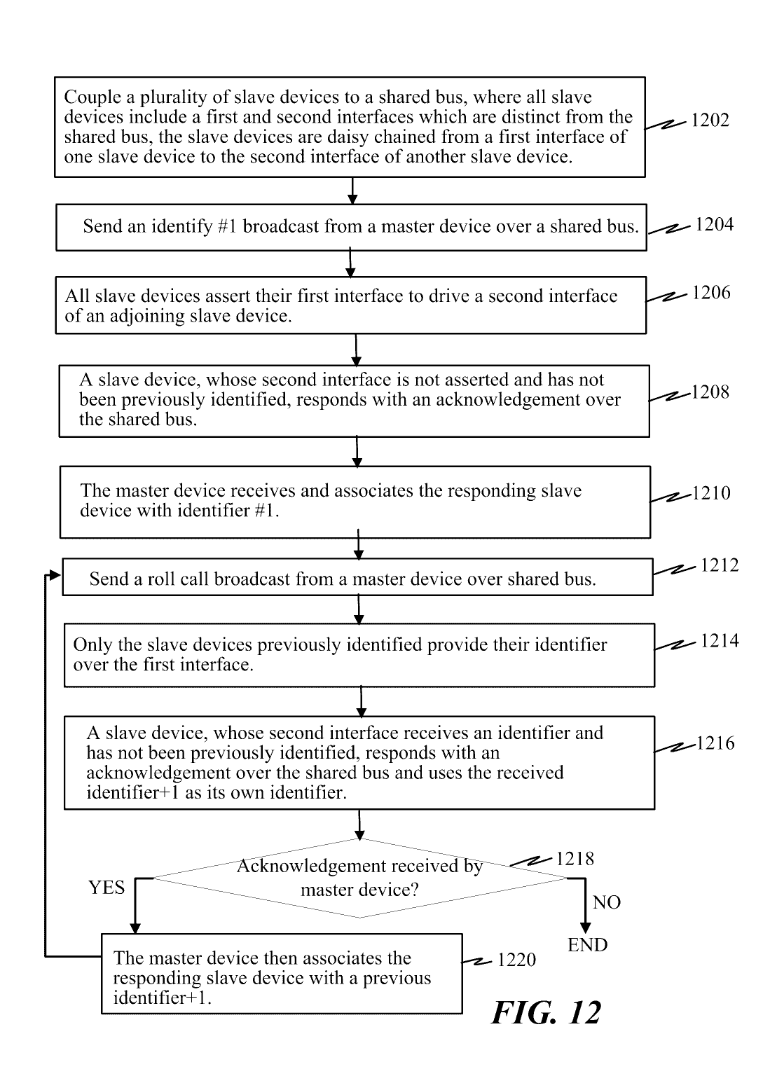

FIG. 12 is a flow diagram illustrating an exemplary method that may be implemented between a master device and a plurality of slave devices coupled to a shared bus to permit the slave devices to self-identify. An example of this method is illustrated in FIG. 11. The plurality of slave devices may be coupled to the shared bus, where all slave devices include a first and second interfaces (e.g., “W” interface and “E” interface of FIG. 3) which are distinct from the shared bus, the slave devices are daisy chained from a first interface of one slave device to the second interface of another slave device 1202. The master device may send an identify #1 broadcast over the shared bus 1204 (e.g., during a boot-up or initialization stage). As previously illustrated in FIG. 11, all previously unidentified slave devices assert their first interface (e.g., “W” interface) to drive a second interface (e.g., “E” interface) of an adjoining slave device 1206. A slave device, whose second interface (“E” interface) is not asserted and has not been previously identified, responds with an acknowledgement over the shared bus 1208.

The master device receives and associates the responding slave device with identifier #1 1210.

Next, the master device may send a roll call broadcast over the shared bus 1212. In response to such roll call broadcast, only the slave devices previously identified a provide their identifier over the first interface 1214. A slave device, whose second interface receives the identifier (e.g., from the adjacent slave device) and has not been previously identified, may respond with an acknowledgement over the shared bus and uses the received identifier+1 as its own identifier 1216.

If the master device receives an acknowledgment to the roll call 1218, the master device then associates the responding slave device with a previous identifier+1 1220. Therefore, the actual identifier is not sent over the shared bus but is instead implicitly conveyed.

This process continues until no acknowledgement is received from the slave devices (i.e., all slave devices have been identified).

### Third Exemplary Approach for Self-Identification of Slave Devices Coupled to a Shared Bus

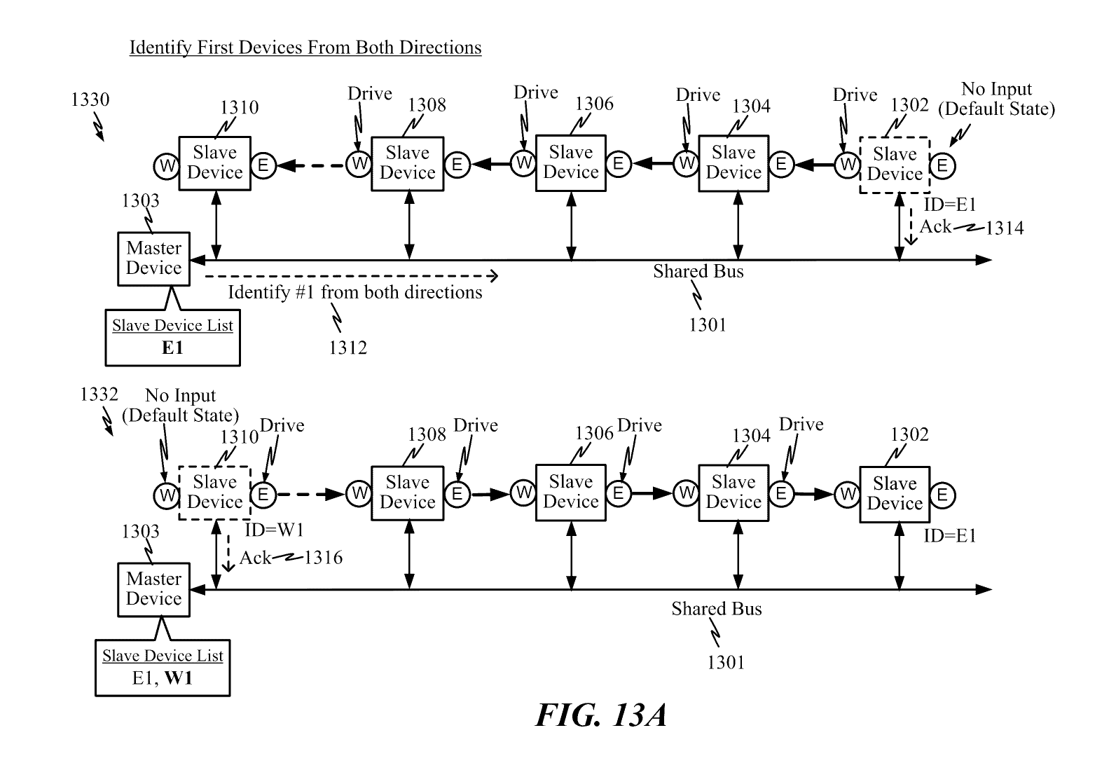

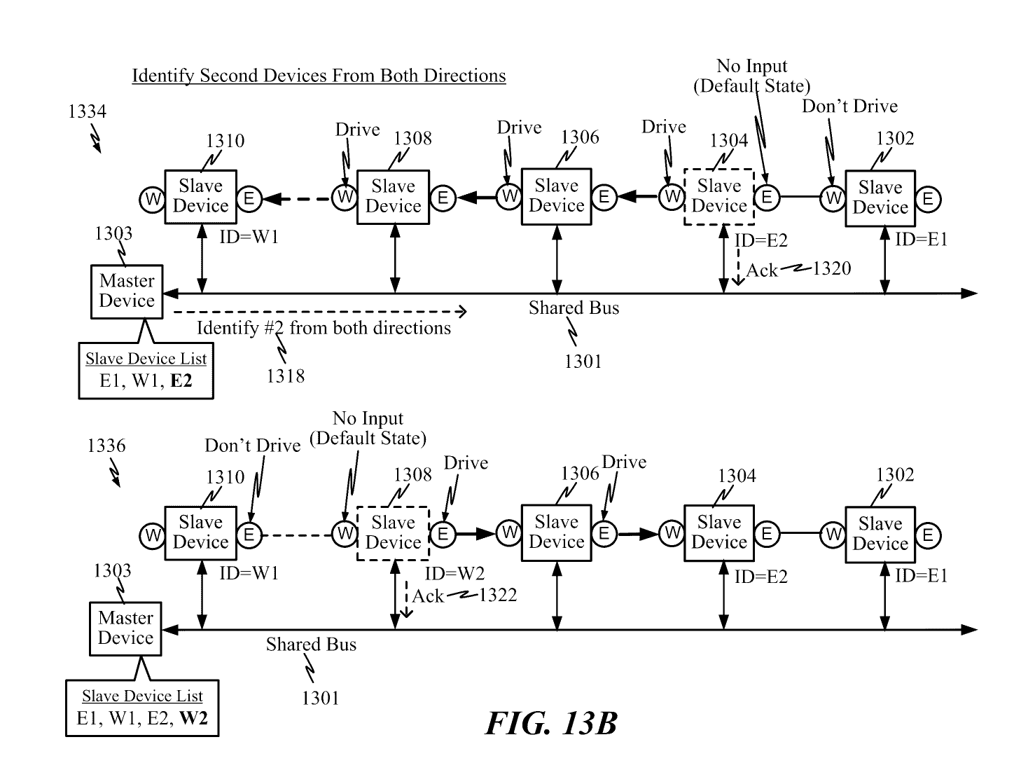

FIG. 13 (comprising FIGS. 13A and 13B) illustrates a bi-directional self-identification process that may be implemented to uniquely identify a plurality of identical slave devices 1302, 1304, 1306, 1308, and 1310 coupled to a shared bus 1301. Note that a master device 1303 is also coupled to the shared bus 1301 and serves to control communications over the shared bus 1301. In this approach, a single broadcast from a master device of the shared bus is used to identify two slave devices.

Note that, in the first approach illustrated in FIG. 3, a relatively large number messages/commands/broadcasts are sent by the master device to permit the slave devices to self-identify. That is, at least one message must be sent by the master device, over the shared bus, for each slave device (coupled to the shared bus) to self-identify.

An alternative approach is provided herein that uses fewer messages, commands, and/or broadcasts than the total number of slave devices coupled to the shared bus. In this approach, each identify message/command/broadcast may allow to identify two slave devices in a daisy chain. That is, for each identify message/command/broadcast transmitted by the master device, two slave devices may self-identify. Consequently, self-identification of slave devices may occur more quickly relative to other approaches.

Each slave device 1302, 1304, 1306, 1308, and 1310 may include a bus interface, which is used to couple to the shared bus 1301, and two interfaces (labeled as “E” and “W”), which are used by the slave devices 1302, 1304, 1306, 1308, and 1310 for the self-identification process. The plurality of slave devices 1302, 1304, 1306, 1308, and 1310 may be daisy chained (e.g., coupled in series, or coupled in a chain) to each other using these two interfaces, with the “W” interface for a first device coupled to the “E” interface for a second device. Consequently, except for the first and last slave device in the chain, each slave device in the chain has its “W” interface and “E” interface coupled to another slave device.

In one example, each of the “E” interfaces and “W” interfaces may be bidirectional interfaces. A bidirectional interface may be one that, in a first mode, may be driven (e.g., to a high or low state) by its slave device and, in a second mode, can sense a change of its default state (i.e., the sensing interface may be weakly pulled up or down but can be driven by another slave device from its default state). In the example, illustrated in FIG. 13A at a first stage 1330, the “W” interfaces may serve to drive an adjacent “E” interface of a different slave device. Meanwhile, the “E” interfaces may merely sense if their state is being changed from a default state. Similarly, as illustrated in FIG. 13A at a second stage 1332, the “E” interfaces may serve to drive an adjacent “W” interface of a different slave device. Meanwhile, the “W” interfaces may merely sense if their state is being changed from a default state.

In one example, the “E” interface and/or “W” interface may be weakly pulled to a default state (e.g., pulled up/high or pulled down/low) by the slave device. In a first direction, the “W” interface of each slave device may be selectively driven high or low (i.e., not floating) opposite the default state of the “E” interface. Therefore, the “W” interface of a first slave device may be selectively driven (e.g., high or low) to set or pull the “E” interface of a second slave device to a state (e.g., high or low) opposite the default state. Consequently, by virtue of the state of its “E” interface, each slave device knows whether it is coupled to another slave device.

Similarly, in a first direction, the “E” interface of each slave device may be selectively driven high or low (i.e., not floating) opposite the default state of the “W” interface. Therefore, the “E” interface of a first slave device may be selectively driven (e.g., high or low) to set or pull the “W” interface of a second slave device to a state (e.g., high or low) opposite the default state. Consequently, by virtue of the state of its “W” interface, each slave device knows whether it is coupled to another slave device.

Initially, the master device 1303 may send an “Identify #1 from both directions” broadcast 1312 over the shared bus 1301. For instance, such “Identify #1 from both directions” broadcast 1312 may be sent upon power-up or boot up of a device that includes the master device 1303, the shared bus 1301, and/or the slave devices 1302, 1304, 1306, 1308, and 1310. At a first stage 1330 seeking to identify a first slave device 1302, all slave devices 1302, 1304, 1306, 1308, and 1310 drive their “W” interface causing the “E” interface of an adjacent slave device in the chain to change from its default state. Only the first slave device 1302 (i.e., the device whose “E” interface does not change from its default state) in the daisy chain of slave devices identifies itself with identifier #E1 responds with an “acknowledge” (Ack) 1314 over the shared bus 1301. From this point forward, that responding first slave device 1302 may be identified as #E1 over the shared bus 1301 by both the master device 1303 and the first slave device 1302. This first device 1302 is identified as a first end of the chain of slave devices.

Upon detection of the acknowledge (Ack) 1314 from the first slave device over the shared bus 1301, a second stage 1332 seeking to identify a second slave device 1310 may start. That is, all slave devices on the daisy chain may be monitoring the shared bus 1301, and upon detecting that the Ack 1314 has been sent over the shared bus 1301 they know that they may initiate the second stage 1332. In this second stage 1314, all of the slave devices 1302, 1304, 1306, 1308, and 1310 stop driving their “W” interface and all previously unidentified slave devices drive their “E” interface. Note that this change (e.g., stop driving the “W” interface and instead drive the “E” interface) may occur immediately and/or automatically upon detecting that an Ack 1314 has been sent over the shared bus 1301. This may cause the “W” interface for an adjacent slave device in the daisy chain to change from its default state. Only a second slave device 1310 (i.e., the device whose “W” interface does not change from its default state) in the daisy chain of slave devices responds with an “acknowledge” (Ack) 1316 over the shared bus 1301. From this point forward, that responding second slave device 1310 may be identified as #W1 over the shared bus 1301 by both the master device 1303 and the second slave device 1310. This second device 1310 is identified as a second end of the chain of slave devices.

Upon receipt of the two acknowledgements 1314 and 1316, the master device 1303 sends an “Identify #2 from both directions” broadcast 1318 over the shared bus 1301. At a third stage 1334, since the first slave device 1302 has already been identified as #E1, the first slave device 1302 and second slave device 1310 know not to respond to the “Identify #2 from both directions” broadcast 1318. Since the first slave device 1302 already has an identifier, it knows not to drive its “W” interface (e.g., it may simply float or drives its “W” interface to a default state). A third slave device 1304, whose “E” interface is no longer driven (or remains at its default state), responds to the “Identify #2 from both directions” broadcast 1318 by sending an acknowledge (Ack) 1320. From this point forward, that responding third slave device 1304 may be identified as #E2 by the master device 1303 and the third device 1304 itself over the shared bus 1301.

Upon detection of the acknowledge (Ack) 1320 from the third slave device 1304 over the shared bus 1301, a fourth stage 1336 seeking to identify a fourth slave device 1308 may start. At the fourth stage 1336, all of the slave devices stop driving their “W” interface and all slave devices 1306 and 1308, not previously identified, drive their “E” interface. This may cause the “W” interface for an adjacent slave device in the daisy chain to change from its default state. Only a fourth slave device 1308 (i.e., the device whose “W” interface does not change from its default state) in the daisy chain of slave devices responds with an “acknowledge” (Ack) 1322 over the shared bus 1301. From this point forward, that responding fourth slave device 1308 may be identified as #W2 over the shared bus 1301 by both the master device 1303 and the fourth slave device 1308.

This process may continue until all slave devices on the shared bus have been identified.

Note that, where the master device has no prior knowledge of the number of slave devices, the master device may send a final “Identify #N in both directions” broadcast to which no slave device responds because all slave devices have been identified. Since the master device 1303 does not receive an “acknowledge” to the “Identify #N from both directions” broadcast, it knows all slave devices on the shared bus 1301 have been identified. Note that, where an odd number of slave devices are connected in the daisy chain, the master device 1303 receives only the first Ack from the slave located in the middle in the chain for the last “Identify #N in both directions” command.

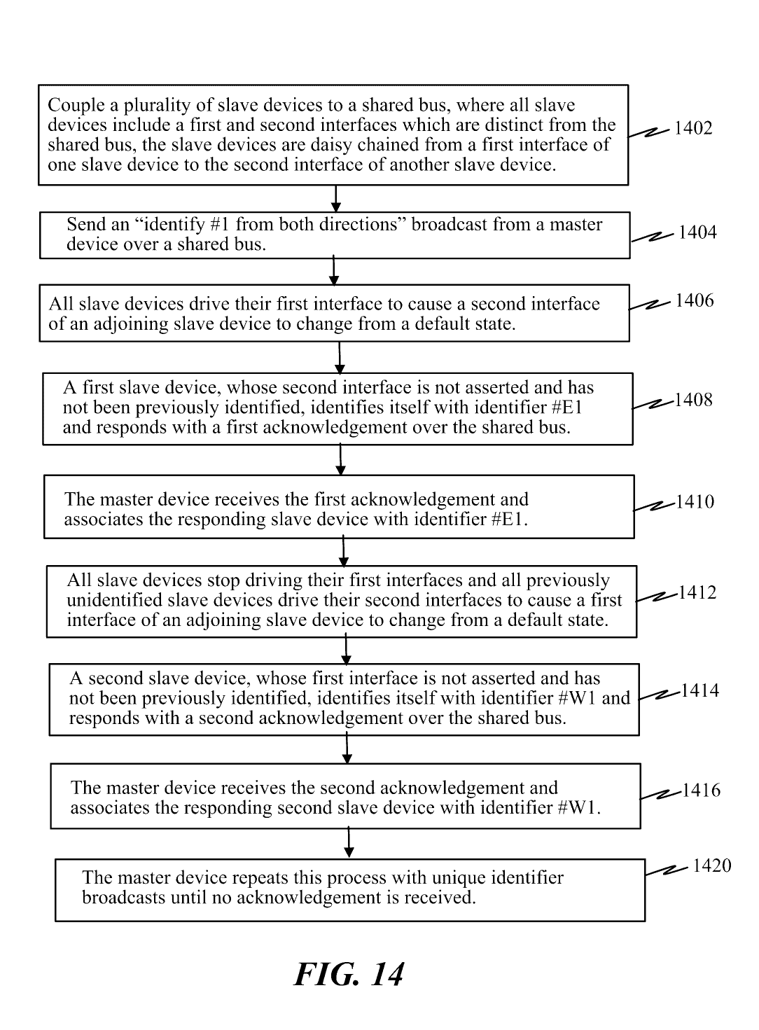

FIG. 14 is a flow diagram illustrating an exemplary method that may be implemented between a master device and a plurality of identical slave devices coupled to a shared bus to permit the slave devices to self-identify. An example of this method is illustrated in FIG. 13. The plurality of slave devices may be coupled to the shared bus, where all slave devices include a first interface and a second interface (e.g., “W” interface and “E” interface of FIG. 3) which are distinct from the shared bus, the slave devices are daisy chained from a first interface of one slave device to the second interface of another slave device 1402. The master device may send an “identify #1 from both directions” broadcast over the shared bus 1404 (e.g., during a boot-up or initialization stage). As previously illustrated in FIG. 13, all previously unidentified slave devices drive their first interface (e.g., “W” interface) to cause a second interface (e.g., “E” interface) of an adjoining slave device to change from a default state 1406. A first slave device, whose second interface (“E” interface) is not asserted (e.g., not changed from its default state) and has not been previously identified, identifies itself with identifier #E1 and responds with a first acknowledgement over the shared bus 1408. The master device receives the first acknowledgement and associates the responding first slave device with identifier #E1 1410.

After the acknowledgement is sensed (on the shared bus) by all slave devices, all slave devices stop driving their first interfaces (“W” interfaces) and all unidentified slave devices drive their second interfaces (“E” interface) to cause a first interface (e.g., “W” interface) of an adjoining slave device to change from a default state 1412. A second slave device, whose first interface (“W” interface) is not asserted (e.g., not changed from its default state) and has not been previously identified, identifies itself with identifier #W1 and responds with a second acknowledgement over the shared bus 1414. The master device receives the second acknowledgement and associates the responding second slave device with identifier #W1 1416.

The master device repeats this process (as illustrated in FIG. 13) with unique identifier broadcasts until no acknowledgement or only a single acknowledgment (for an odd number of slave devices in the daisy chain) is received 1420.

### Fourth Exemplary Approach for Self-Identification of Slave Devices Coupled to a Shared Bus

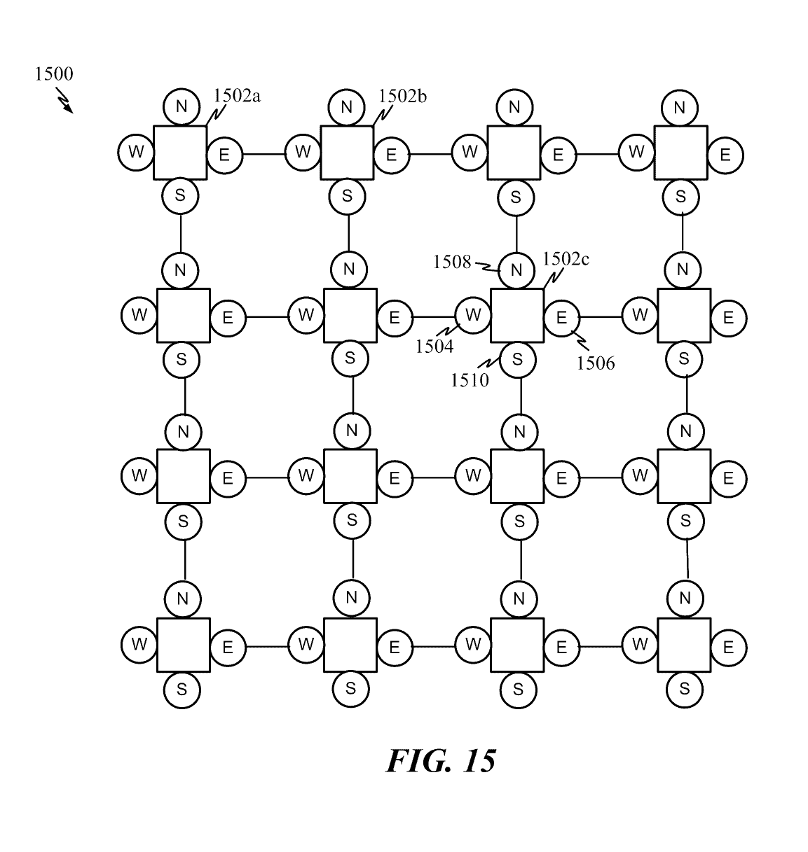

FIG. 15 illustrates a grid array configuration of a plurality of identical slave devices, where each slave device has four interfaces separate from a shared bus interface. In this approach, each slave device includes four interfaces (“W”, “E”, “N”, and “S”), instead of two interfaces (“W” and “E”), which may allow to identify slave devices more quickly than when two interfaces are used. In this exemplary grid configuration 1500, a plurality of slave devices 1502 may be coupled to a shared bus (not shown) and also to each other over two to four interfaces. For example, a first slave device 1502a may have its “E” interface and “S” interface coupled to other slave devices. A second slave device 1502b may have its “W” interface, “E” interface, and “S” interface coupled to other slave devices. A third slave device 1502c may have its “W” interface, “E” interface, “N” interface, and “S” interface coupled to other slave devices. In various implementations, each of the “W”, “E”, “N”, and “S” interfaces may be unidirectional interfaces or bidirectional interfaces.

Note that, in this approach, daisy chaining between slave devices may be performed in two dimensions (e.g., two directions of a grid pattern). In other implementations, a three dimensional or n-dimensional daisy chaining of slave devices may also be implemented. The various techniques and approaches illustrated in FIGS. 3, 11, and 13 (or variations/combinations thereof) may be implemented on this two dimensional grid configuration 1500 of slave devices to allow the slave devices to self-identify to a master device that controls a shared bus.

The use of more than two interfaces per slave device (in addition to a shared bus) may allow generating a faster and/or more precise identification of a slave device configuration, pattern, or positional configuration.

In one exemplary implementation, the master device may have prior knowledge of the total number and structure/arrangement of slave devices in such grid configuration 1500. However, since the slave devices are identical, a self-identify approach is performed to allow each slave device to obtain a unique identifier.

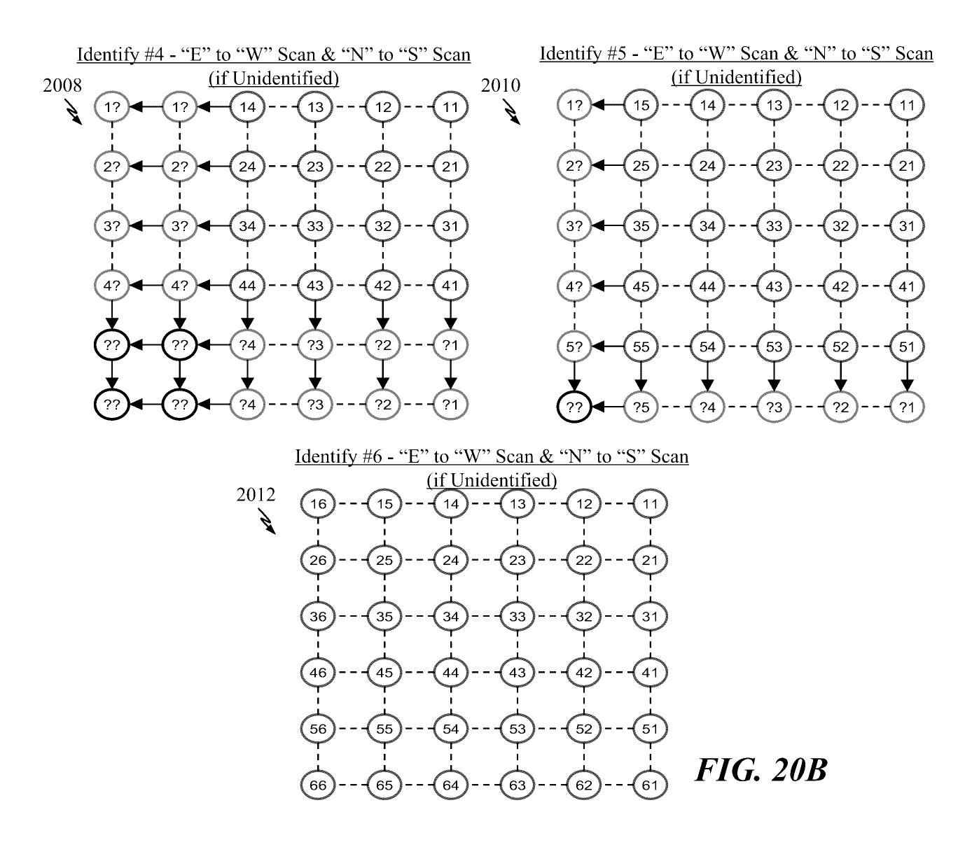

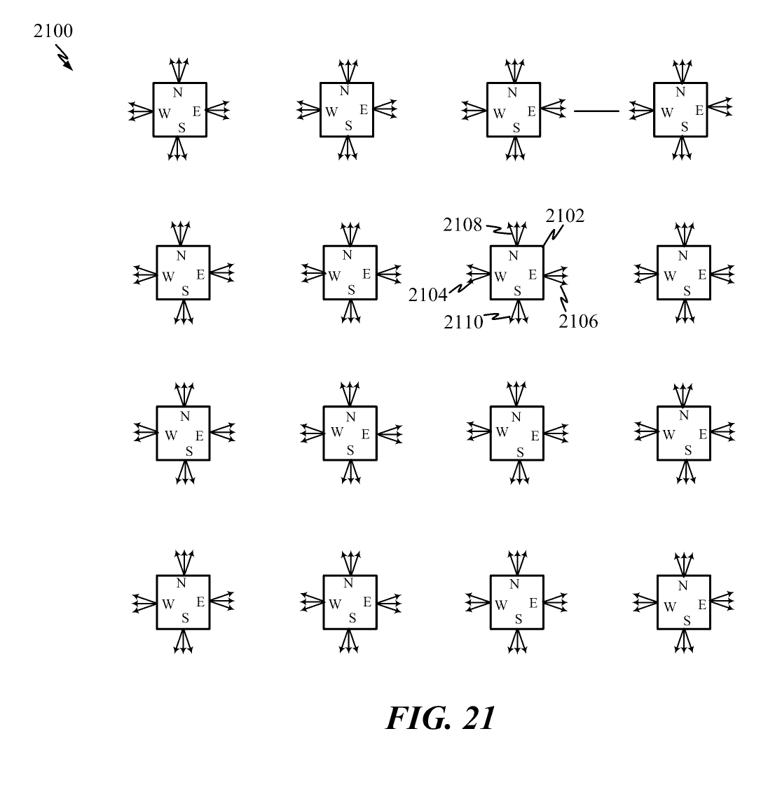

FIG. 21 illustrates another grid array configuration of a plurality of identical slave devices, where each slave device has four contactless interfaces separate from a shared bus interface. In this approach, each slave device includes four contactless interfaces (“W”, “E”, “N”, and “S”), instead of two interfaces (“W” and “E”), which may allow to identify slave devices more quickly than when two interfaces are used. In this exemplary grid configuration 2100, a plurality of slave devices 2102 may be communicatively coupled to a shared bus (not shown) and also to each other over two to four contactless interfaces (e.g., short-range radio or light emitters and/or receivers). In one example, a slave device 2102 may use its “W” interface 2104, “E” interface 2106, “N” interface 2108, and “S” interface 2110 to communicate with other slave devices. In various implementations, each of the “W”, “E”, “N”, and “S” interfaces may be unidirectional interfaces or bidirectional interfaces.

According to a first approach, unidirectional scans of a two-dimensional grid configuration of slave devices may be used to allow a plurality of slave devices to self-identify.

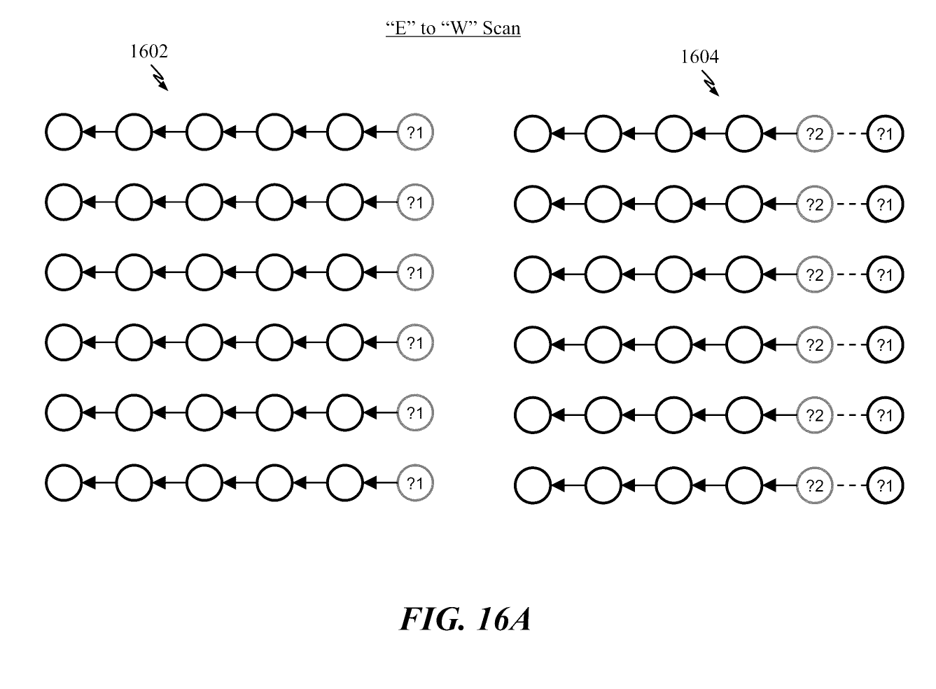

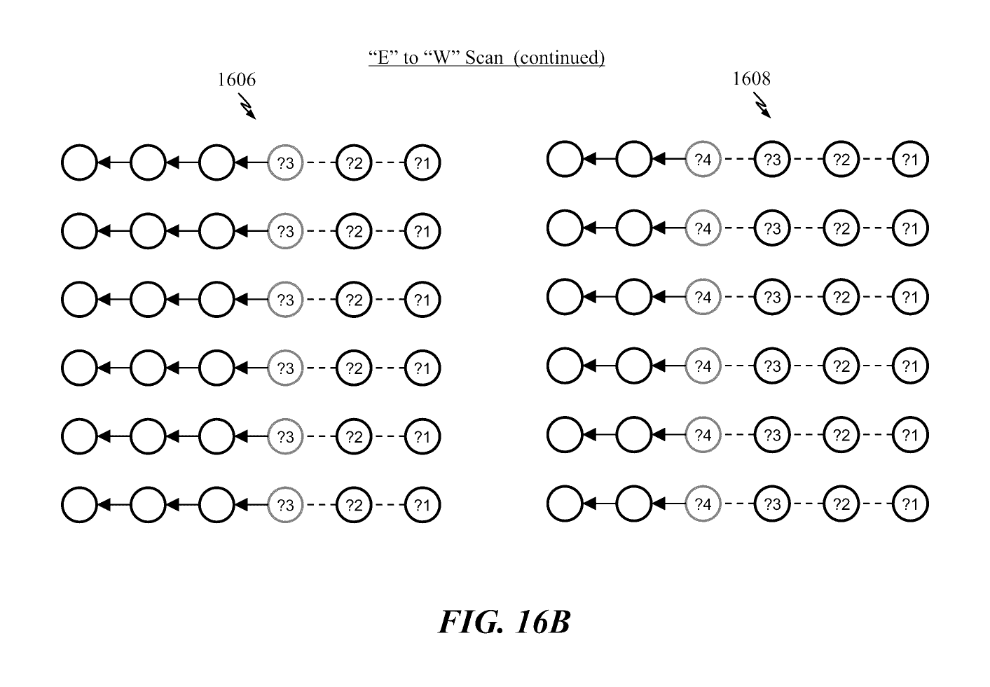

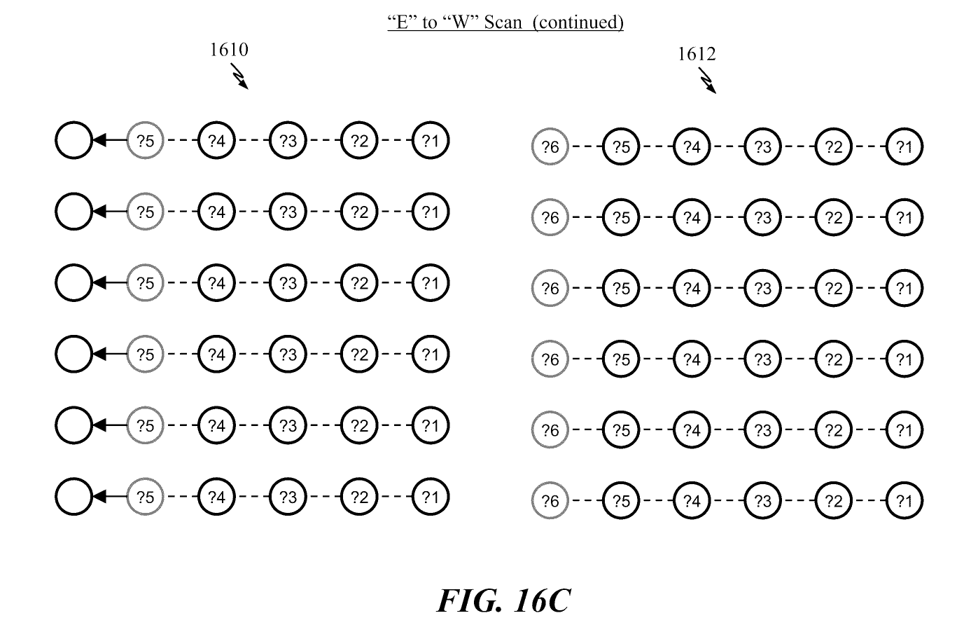

FIG. 16 (comprising FIGS. 16A, 16B, and 16C) illustrates a first part of a unidirectional scan process that allows a plurality of identical slave devices in a two dimensional array and coupled to a shared bus to self-identify to a master device on the shared bus. In one example, the grid configuration 1500 of slave devices of FIG. 15 may be used for illustration. The master device may send one or more “E”-to-“W” broadcasts that causes slave devices along each column of the grid to iteratively identify itself as “x1”, “x2” . . . “x6” over a plurality of stages 1602, 1604, 1606, 1608, 1610, and 1612. The identification along each column may be similar to the daisy chain approaches of FIGS. 3 and 11, for example. Through this “E”-to-“W” scan, each slave device may partially identify itself (e.g., via its column number).

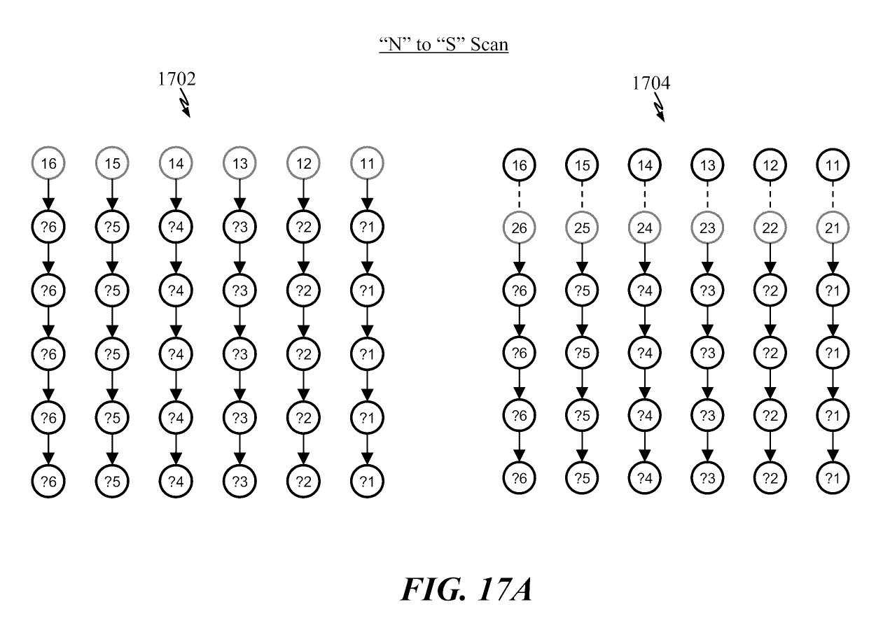

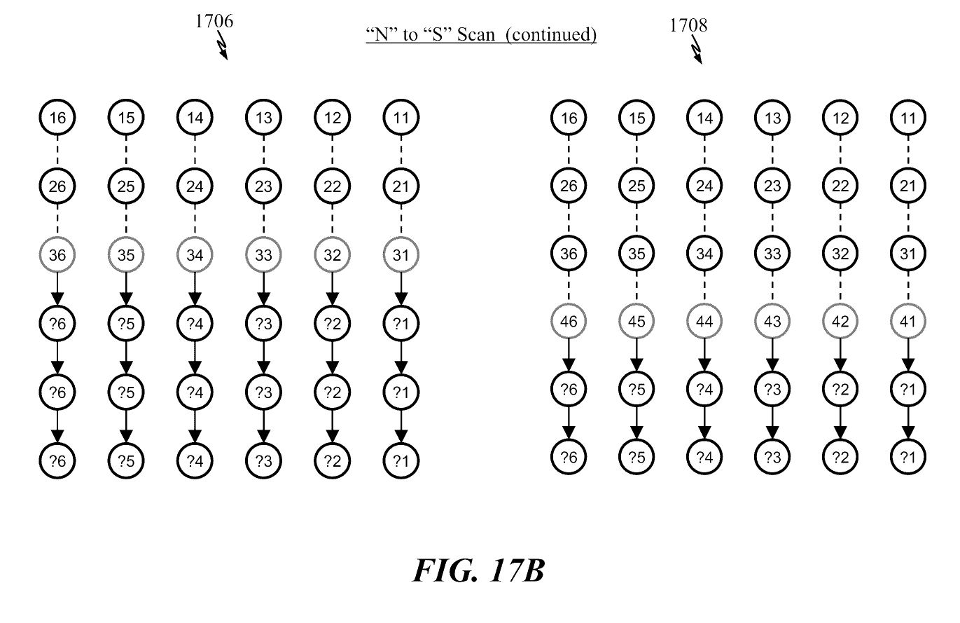

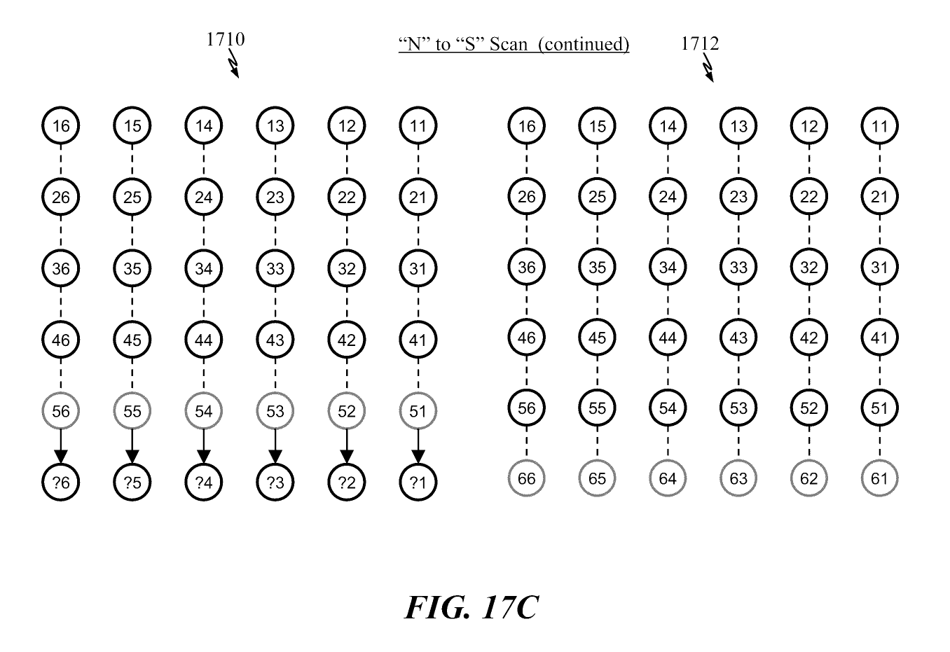

FIG. 17 (comprising FIGS. 17A, 17B, and 17C) illustrates a second part of a unidirectional scan process that allows a plurality of identical slave devices in a two dimensional array and coupled to a shared bus to self-identify to a master device on the shared bus. In this diagram, the slave devices of FIG. 16 are now scanned in a different direction. The master device may send one or more “N”-to-“S” broadcasts that causes slave devices along each row of the grid to iteratively identify itself as “1y”, “2y” . . . “6y” over a plurality of stages 1702, 1704, 1706, 1708, 1710, and 1712. The identification along each column may be similar to the daisy chain approaches of FIGS. 3 and 11, for example. Through this “N”-to-“S” scan, each slave device may identify itself (e.g., via its row number). Having identified its own column number in FIG. 16, each slave device now fully identifies itself by finding its row number. Therefore, a slave device identifier may be composed of column and row numbers.

According to a second approach, bidirectional scans of a two-dimensional grid configuration of slave devices may be used to allow a plurality of slave devices to self-identify.

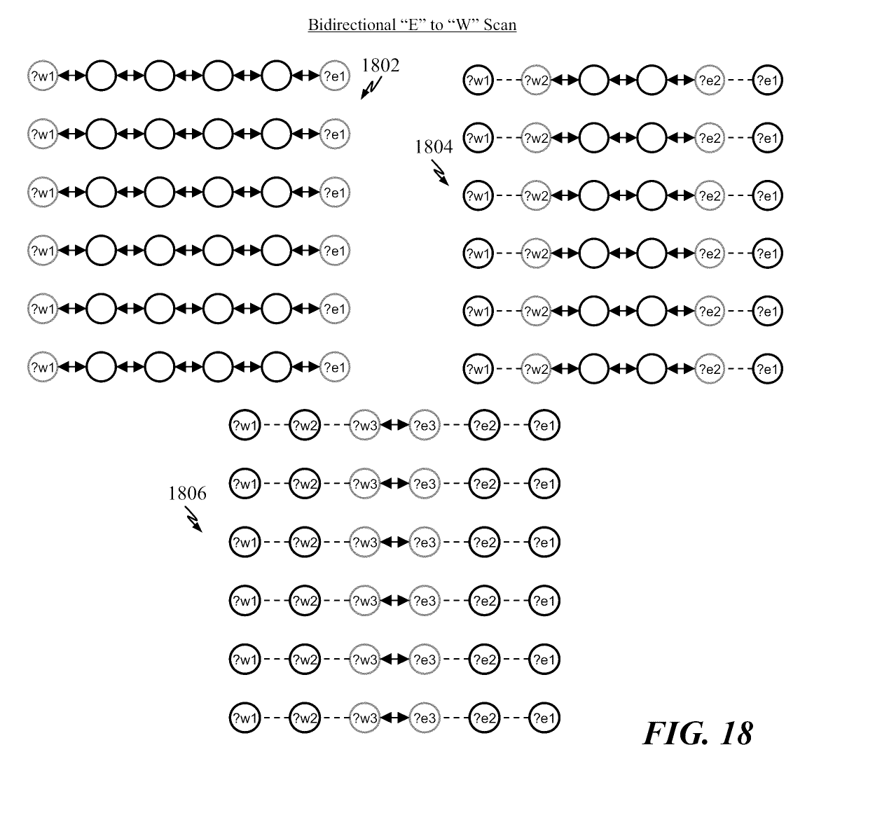

FIG. 18 illustrates a first part of a bidirectional scan process that allows a plurality of identical slave devices in a two dimensional array and coupled to a shared bus to self-identify to a master device on the shared bus. In one example, the grid configuration 1500 of slave devices of FIG. 15 may be used for illustration. The master device may send one or more “E”-to-“W” broadcasts that causes slave devices along each column of the grid to iteratively identify itself as “xe1”, “xw1” . . . “xe3, “xw3” over a plurality of bidirectional stages 1802, 1804, and 1806. The identification along each column may be similar to the daisy chain approach of FIG. 13, for example. Through this “E”-to-“W” scan, each slave device may partially identify itself (e.g., via its column number).

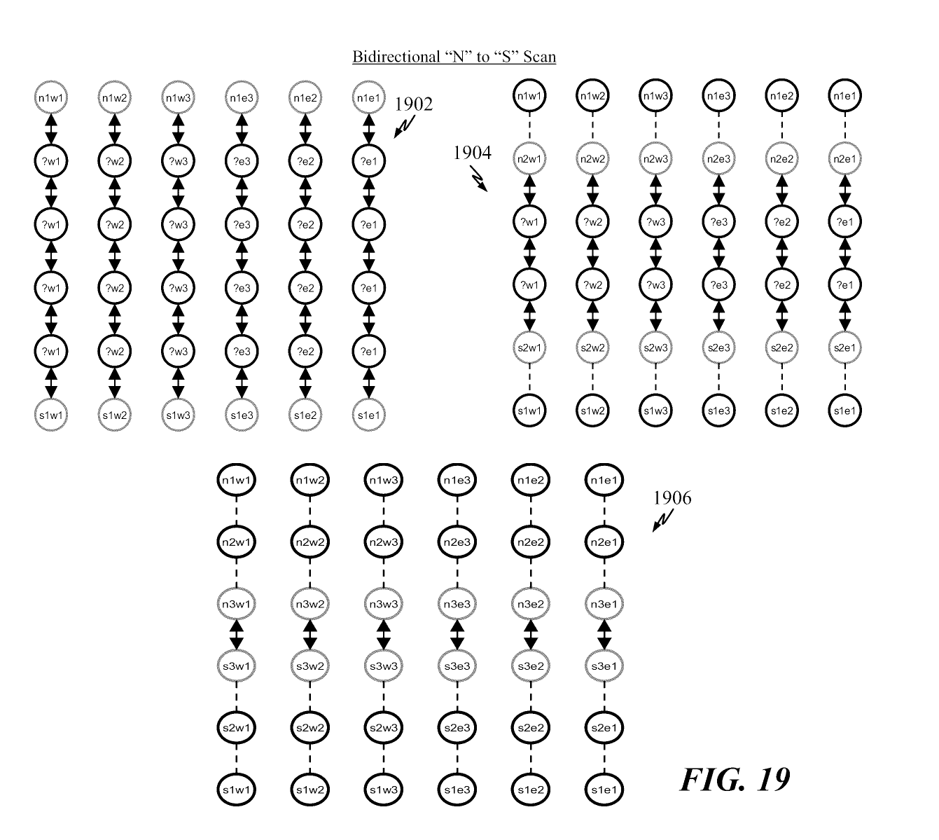

FIG. 19 illustrates a second part of a bidirectional scan process that allows a plurality of identical slave devices in a two dimensional array and coupled to a shared bus to self-identify to a master device on the shared bus. In this diagram, the slave devices of FIG. 18 are now scanned in a different direction. The master device may send one or more “N”-to-“S” broadcasts that causes slave devices along each row of the grid to iteratively identify itself as “n1y”, “s1y” . . . “n3y”, “s3y” over a plurality of stages 1902, 1904, and 1906. The identification along each column may be similar to the daisy chain approaches of FIG. 13, for example. Through this “N”-to-“S” scan, each slave device may identify itself (e.g., via its row number). Having identified its own column number in FIG. 18, each slave device now fully identifies itself by finding its row number. Therefore, a slave device identifier may be composed of column and row numbers.

The self-identification process thus serves to allow each slave device in the grid configuration to identify itself (e.g., so that each slave devices obtains its own identifier).

In some implementations, the master device may have prior knowledge of the number of slave devices in the grid configuration 1500 and their exact locations. In other implementations, hot-plugging (e.g., dynamic insertion) of slave devices may be permitted as long as the master device knows the structure of the slave devices.

In yet other alternative approaches, either of the approaches illustrated in FIGS. 16 & 17 and/or FIGS. 18 & 19 may be more efficiently implemented by performing the scanning in two directions concurrently.

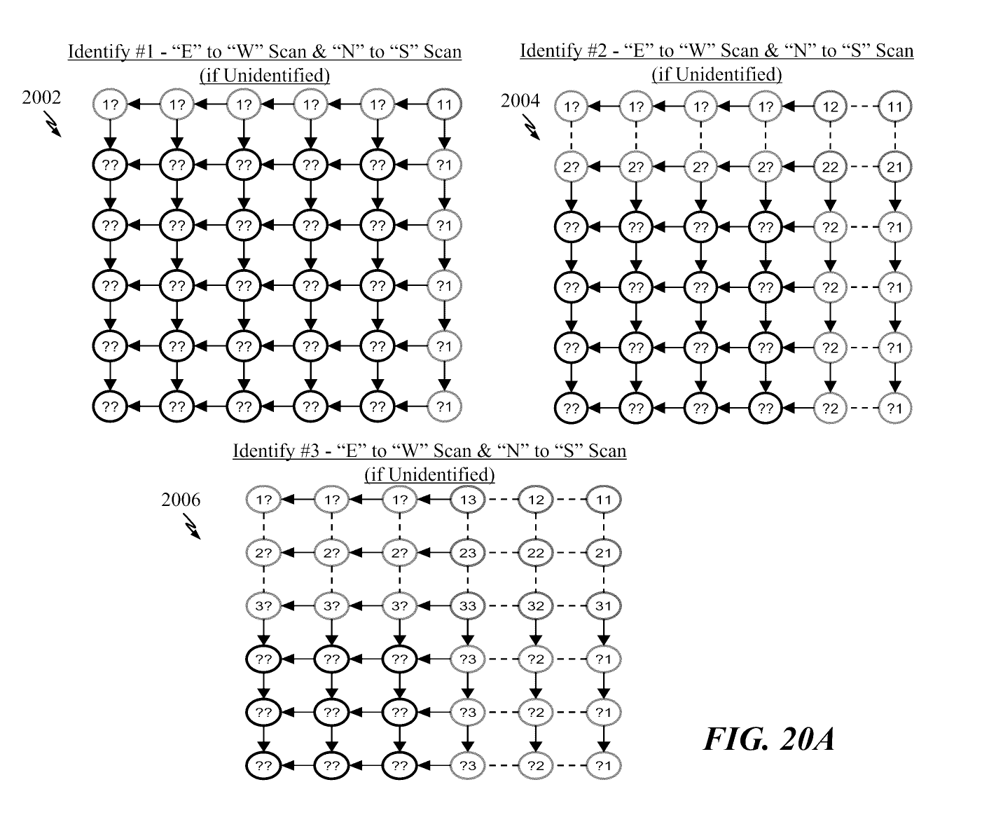

FIG. 20 (comprising FIGS. 20A and 20B) illustrates another unidirectional scan process that allows a plurality of identical slave devices in a two dimensional array and coupled to a shared bus to self-identify to a master device on the shared bus. In one example, the grid configuration 1500 of slave devices of FIG. 15 may be used for illustration. In this example, the unidirectional approaches illustrated in FIGS. 16 and 17 may be implemented concurrently. However, an alternative approach may similarly combine the approaches illustrated in FIGS. 18 and 19.

At a first stage 2002, the master device may send an “Identify #1 broadcast/command” that causes all “W” interfaces and all “S” interfaces to be asserted (e.g., for all not-yet-identified slave devices) thereby causing the corresponding “E” and “N” interfaces to change from a default state. The slave devices may sense their “E” and “N” interfaces to determine whether they are in a default state or not. If the “E” interface is at its default state, then the slave device may recognize it is in a first column. Such slave devices may have a partially defined identifier of “?1”, where “?” is to be defined in a subsequent scan. Similarly, if the “N” interface is at its default state, then the slave device may recognize it is in a first row. Such slave devices may have a partially defined identifier of “1?”, where “?” is to be defined in a subsequent scan. If both the “E” and “N” interfaces are at their default state, then the slave device may identify itself as “11”.

At a second stage 2004, the master device may send an “Identify #2 broadcast/command” that causes all “W” interfaces and all “S” interfaces to be asserted for all not-yet-identified slave devices, thereby causing the corresponding “E” and “N” interfaces to change from a default state. Note that, for slave devices that have already identified their row, they do not assert their “S” interfaces; and for slave devices that have already identified their column, they do not assert their “W” interfaces. The slave devices may again sense their “E” and “N” interfaces to determine whether they are in a default state or not. If the “E” interface is at its default state, then the slave device may recognize it is in a second column. Such slave devices may have a partially defined identifier of “?2”, where “?” is to be defined in a subsequent scan. Similarly, if the “N” interface is at its default state, then the slave device may recognize it is in a second row. Such slave devices may have a partially defined identifier of “2?”, where “?” is to be defined in a subsequent scan. If both the “E” and “N” interfaces are at their default state, then the slave device may identify itself as “22”. As a slave device defines both its row and column in this manner, it is now self-identified and does not asserts its “W” or “S” interfaces upon receipt of subsequent identify broadcasts/commands. This process continues through a third stage 2006, fourth stage 2008, fifth stage 2010, and sixth stage 2012 until all slave devices have self-identified.

Exemplary Master Device and Method Operational Thereon

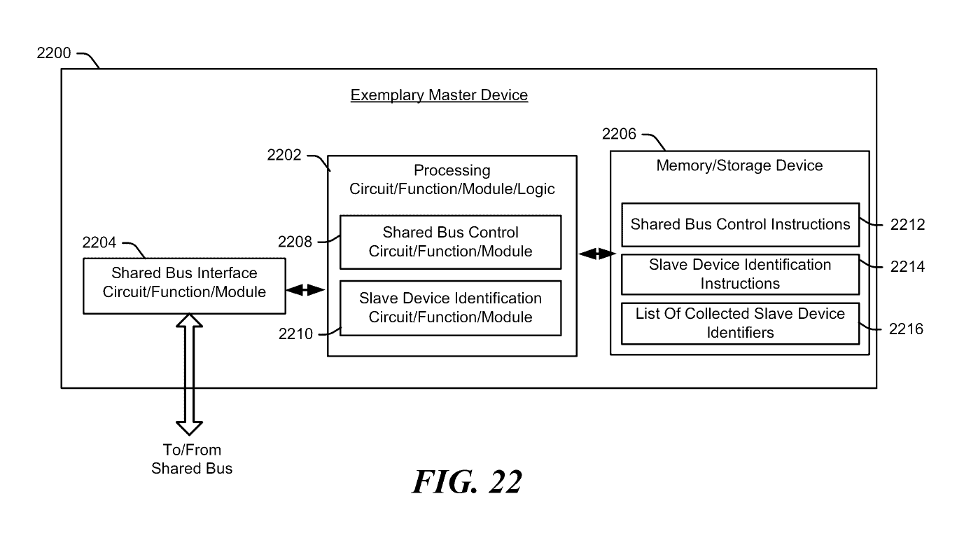

FIG. 22 is a block diagram illustrating an exemplary master device 2200 that may be configured to facilitate self-identification of a plurality of identical devices on a shared bus. The master device 2200 may include a processing circuit, function, module, and/or logic 2202 coupled to a shared bus interface circuit/function/module 2204 and a memory/storage device 2206. The shared bus interface circuit/function/module 2204 may allow the master device 2200 to communicate and/or manage communications over a multi-line bus (e.g., two-line bus) to which a plurality of identical slave devices may be coupled. The processing circuit, function, module, and/or logic 2202 may include a shared bus control circuit, function, module 2208 that may be configured to implement one or more shared bus control instructions 2212 that permits the master device to control communications over the shared bus. Additionally, the processing circuit, function, module, and/or logic 2202 may also include a slave device identification circuit, function, and/or module 2210 configured to implement one or more slave device identification instructions 2214 that permits the slave devices on the shared bus to self-identify and/or notify the master device that is has self-identified over the shared bus. In one example, such notification to the master device 2200 that a slave device has self-identified does not include an explicit identifier for the slave device. For instance the notification may be a simple acknowledge (ack) in response to the broadcast/command sent over the shared bus, where such acknowledge does not include the slave device identifier. In one implementation, the master device and slave device may use a pre-arranged protocol, such as illustrated in FIGS. 3, 11, and/or 13, to implicitly agree on a device identifier (e.g., by agreeing that a responding/acknowledging slave device takes the identifier implied by the specific broadcast/command). In another implementation, the master device may have prior knowledge of the number of slaves and/or their configuration or relative arrangement, but uses a protocol, such as illustrated in FIGS. 16, 17, 18, and/or 19, to permit each of the identical slave device to obtain a unique identifier (i.e., distinct from other identifiers) by self-identifying. This permits the master device to specifically address each of the slave devices using this unique identifier over the shared bus.

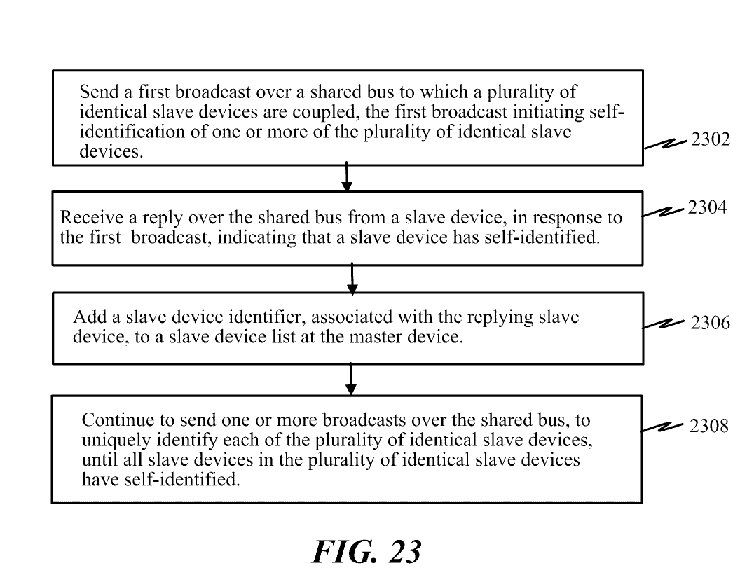

FIG. 23 illustrates a method that may be operational on a master device to facilitate self-identification by one or more identical slave devices. Upon startup, initialization, and/or boot-up, a master device may send a first broadcast over the shared bus to which a plurality of identical slave devices are coupled, the first broadcast initiating/triggering self-identification of one or more of the plurality of identical slave devices 2302. The first broadcast may simply request that the slave devices self-identify (i.e., without specifically assigning an identifier to a slave device). The identifier for each slave device is not explicitly provided to each slave device by the master device. Additionally, the identifier for each slave device is not preconfigured into the slave device. Instead, in response to the first broadcast, the master device may receive a reply over the shared bus from a slave device indicating a slave device has self-identified 2304. Note that the reply may not explicitly provide an identifier for the replying slave device. Instead, the identifier may be implicit, e.g., based on the order of replies, or based on which broadcast is sent (e.g., Identify #1, Identify #2, . . . Identify #n).

Therefore, the reply may simply be an acknowledge message and may not necessarily include an explicit identifier.

The master device may add a slave device identifier, associated with the replying slave device, to a slave device list 2306. The master device may continue to send one or more broadcasts over the shared bus, to uniquely identify each of the plurality of identical slave devices, until all slave devices in the plurality of identical slave devices have self-identified 2308. For instance, as long as a reply is received to a broadcast, the master device may continue to send broadcasts in order to identify all slave devices coupled to the bus. The master device knows all slave devices have been identified when no reply is received to a broadcast over the shared bus. Alternatively, if the master device knows the total number of slave devices coupled to the shared bus, it may stop sending broadcasts once it has received a number of replies equaling the total number of slave devices.

Subsequently, the master device may use the slave device identifiers in the list to send communications specifically addressed to a particular slave device. For instance, the master device may send a communication over the shared bus specifically addressed to a first slave device using a corresponding first identifier, in the slave device list, associated with the first slave device.

In some implementations, the master device may control access to the shared bus by the plurality of slave devices. That is, the master device may determine whether a slave device may communicate over the shared bus and/or may instruct the slave device when it may communicate over the shared bus.

As illustrated in the approaches of FIGS. 3 and 11, the first broadcast may indicate to the plurality of slave devices to identify a first slave device in a daisy chain of slave devices.

As illustrated in the approach of FIG. 3, each of the one or more broadcasts may be distinct from each other and implies an identifier.

As illustrated in the approach of FIG. 11, each of the one or more broadcasts (e.g., roll call) is the same and does not imply an identifier.

As illustrated in the approach of FIG. 13, a single broadcast may result in two replies from two different slave devices, and each of the two different slave devices is associated with a different identifier based on the order in which the replies are received.

As illustrated in the approaches of FIGS. 15, 16, 17, 18, 19, and 20, the slave device list may include a plurality of slave device identifiers and may be indicative of a two dimensional arrangement of the plurality of slave devices.

As illustrated in the approaches of FIGS. 15, 16, 17, 18, 19, and 20, the slave device list may include a plurality of slave device identifiers and may be indicative of an n-dimensional arrangement of the plurality of slave devices.

### Exemplary Slave Device and Method Operational Thereon

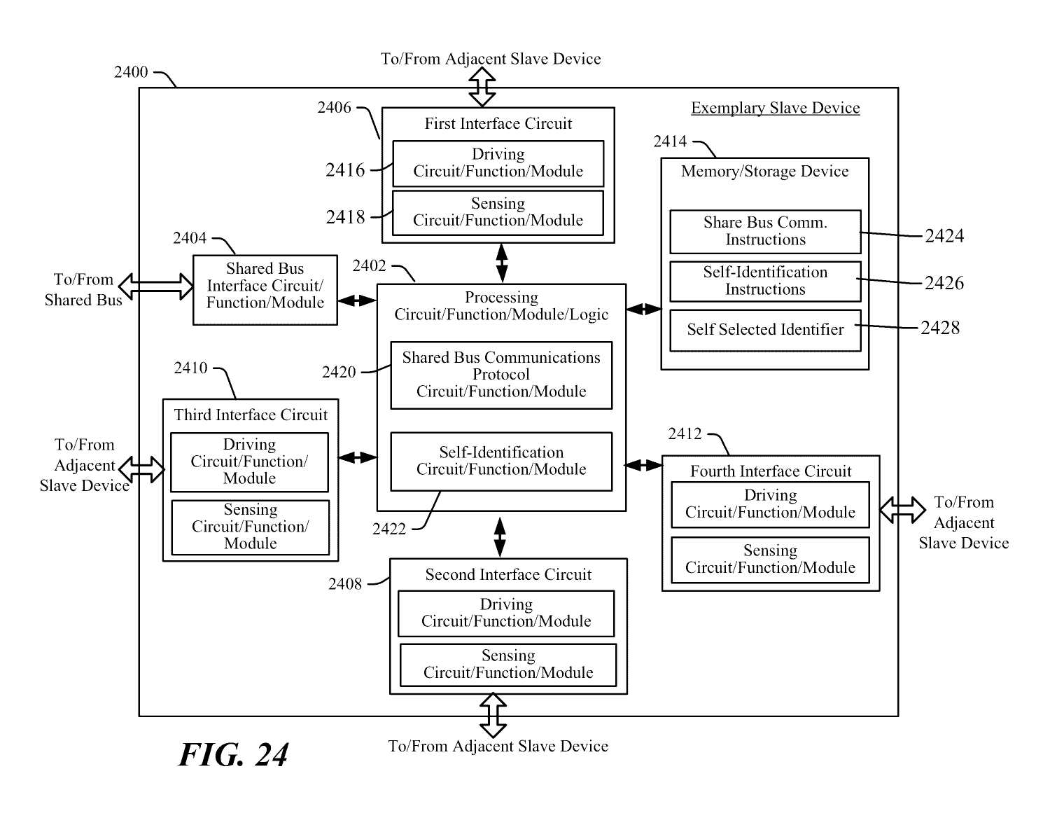

FIG. 24 is a block diagram illustrating an exemplary slave device 2400 that may be configured to self-identify and distinguish itself from a plurality of identical devices coupled to a shared bus. The slave device 2400 may include a processing circuit, function, module, and/or logic 2402 coupled to a shared bus interface circuit/function/module 2404 and a memory/storage device 2406. The shared bus interface circuit/function/module 2404 may allow the slave device 2400 to communicate and/or reply to communications over a multi-line bus (e.g., two-line bus) under the control of a master device.

The slave device may include a plurality of additional interfaces 2406, 2408, 2410, and 2412 distinct from the shared bus interface circuit, function, and/or module 2404. These additional interfaces may be two, three, four, five, six, or more interfaces that are specifically used to couple the slave device to other slave devices (e.g., in a daisy chain or in a grid pattern) for the purpose of self-identification of the slave devices. In this example, four interfaces 2406, 2408, 2410, and 2412 are included in the slave device 2400. Note that, in one example, each of the interfaces may be single line interfaces.

The processing circuit, function, module, and/or logic 2402 may include a shared bus communications protocol circuit, function, and/or module 2420 that may be configured to receive and send communications according to a protocol implemented over the shared bus via the shared bus interface circuit, function, and/or module 2404. The processing circuit, function, module, and/or logic 2402 may also include a self-identification circuit, function, 2422 that is configured to perform self-identification using the plurality of interface circuits 2406, 2408, 2410, and 2412. For instance, the self-identification circuit, function, 2422 may perform one or more of the methods, steps, functions, and/or approaches illustrated in FIGS. 3-18. The slave device 2400 may selectively assert/drive or sense each interface circuits 2406, 2408, 2410, and/or 2412 based on the broadcast received over the shared bus and whether or not the slave device has already self-identified.

Based on the receipt of one or more broadcasts over the shared bus (via the shared bus interface circuit, function, and/or module 2404), the slave device 2400 may obtain a self-assigned or self-selected identifier which it then stores 2428 in the memory/storage device 2414. Note that the slave device identifier 2428 is not provisioned with a unique device identifier during manufacturing. Instead, the slave device identifier 2428 may be self-selected by the slave device during each boot-up or initialization of the slave device 2400 (e.g., every time the device that includes the master device, shared bus, and slave device starts up, power cycles, or resets).

Note that the reply from the slave device 2400 to the master device may not be explicitly communicated to the master device over the shared bus. Instead, such slave device identifier may be implicit in, for example, the order of the replies from different slave devices or based on the preceding broadcast(s) (e.g., where the preceding broadcasts imply an identifier).

The memory/storage device 2414 may also store shared bus communication instructions 2424, which may serve to communicate over the shared bus, and self-identification instructions 2426 which may serve to perform self-identification to the master device.

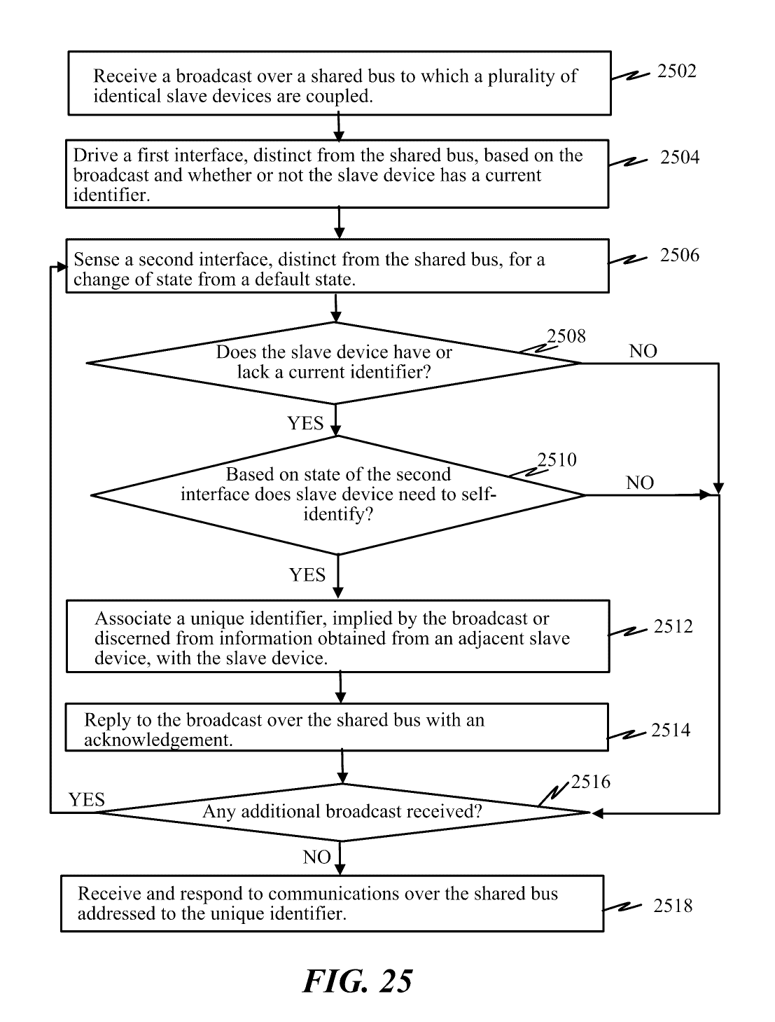

FIG. 25 illustrates a method that may be operational on a slave device to self-identify. A slave device may receive a broadcast over a shared bus to which a plurality of identical slave devices are coupled 2502. In one example, the broadcast may be an explicit self-identify broadcast which is understood by slave devices to perform one or more operations to assist the receiving slave devices in self-identifying. In response, the slave device may drive a first interface (e.g., selectively pull up or down of a state different from a default state for a second interface), distinct from the share bus, based on the broadcast and whether or not the slave device has a current identifier 2504. Additionally, the slave device may sense a second interface, distinct from the shared bus, for a change of state from a default state 2506.

If the slave device already has a current identifier (e.g., self-identified to the master device), then it need not proceed 2508.

If the slave device does not have a current identifier it may determine whether it should reply over the shared bus based on the state of the second interface 2510. For instance, as illustrated in FIG. 3, if the second interface (e.g., “E” interface) remains at the default state, this may indicate that the slave device should send a reply. Alternatively, as illustrated in FIG. 11, if the second interface (e.g., “E” interface) is driven to a different state from its default state, this may indicate that the slave device should send a reply.

If the slave device ascertains that it should respond, it may associate itself with a unique identifier, implied by broadcast or discerned information obtained from an adjacent slave device 2512. For example, as illustrated in FIG. 3, the identifier may be implied by the specific broadcast (e.g., “Identify #1”, “Identify #2”, etc.). Alternatively, as illustrated in FIG. 11, an adjacent slave device may provide its identifier to another slave device to permit it to select a unique identifier (e.g., increment identifier for adjacent slave device by one).

The slave device may then reply to the broadcast over the shared bus 2514. For instance, such reply may be a simple acknowledge and may not include an explicit identifier for the slave device. That is, the master device may simply increment its last identifier in an identifier list and use that as the unique identifier for the responding slave device (with the slave device doing the same). Therefore, both the master device and slave device use the same identifier even though such identifier is not explicitly transmitted over the shared bus. Consequently, the reply implicitly indicates the unique identifier.

The slave device may monitor the shared bus to ascertain whether any additional broadcast are received 2516. If so, the process repeats. Otherwise, the slave device may receive and/or respond to communications over the shared bus addressed to the unique identifier 2518.

In one example, the unique identifier is not explicitly provided to the slave device. Additionally, the unique identifier may not be preconfigured into the slave device.

According to one aspect, the method may further include: (a) receiving one or more broadcasts over the shared bus and/or (b) selectively driving or sensing on the first interface and/or second interface based on the on the one or more broadcasts and whether or not the slave device has a current identifier.

One or more of the components, steps, features, and/or functions illustrated in the Figures may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in the Figures may be configured to perform one or more of the methods, features, or steps described in the Figures. The novel algorithms described herein may also be efficiently implemented in software and/or embedded in hardware.

In addition, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices, and/or other machine-readable mediums for storing information. The term “machine readable medium” includes, but is not limited to portable or fixed storage devices, optical storage devices, wireless channels and various other mediums capable of storing, containing, or carrying instruction(s) and/or data.

Furthermore, embodiments may be implemented by hardware, software, firmware, middleware, microcode, or any combination thereof When implemented in software, firmware, middleware, or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A device, comprising:
a shared bus interface; and
a processing circuit coupled the shared bus interface, the processing circuit configured to:
send a first broadcast over the shared bus to which a plurality of identical slave devices are coupled, the first broadcast initiating self-identification of one or more of the plurality of identical slave devices,
receive a reply over the shared bus from a slave device, in response to the first broadcast, indicating that a slave device has self-identified,
and
continue to send one or more broadcasts over the shared bus, to uniquely identify each of the plurality of identical slave devices, until all slave devices in the plurality of identical slave devices have self-identified.

2. The device of claim 1, wherein the processing circuit is further configured to:
send a communication over the shared bus specifically addressed to a first slave device using a corresponding first identifier, in a slave device list, associated with the first slave device.

3. The device of claim 1, wherein a unique identifier for each of the plurality of identical slave devices is not explicitly provided to each slave device by the device.

4. The device of claim 1, wherein the device knows all slave devices have been identified when no reply is received to a broadcast over the shared bus.

5. The device of claim 1, wherein the device has prior knowledge of a total number of the plurality of identical slave devices coupled to the shared bus, and the device stops sending the one or more broadcasts once that total number of the plurality of identical slave devices have been uniquely identified.

6. The device of claim 1, wherein a unique identifier for each slave device in the plurality of identical slave devices is not preconfigured into the slave devices.

7. The device of claim 1, wherein the reply implicitly indicates a unique identifier for the replying slave device but does not include the identifier.

8. The device of claim 1, wherein the processing circuit is further configured to:
control access to the bus shared by the plurality of identical slave devices.

9. The device of claim 1, wherein the first broadcast indicates to the plurality of identical slave devices to identify a first slave device in a daisy chain of slave devices.

10. The device of claim 1, wherein each of the one or more broadcasts is distinct from each other and implies a unique slave device identifier.

11. The device of claim 1, wherein each of the one or more broadcasts is the same and does not imply a unique slave device identifier.

12. The device of claim 1, wherein a single broadcast results in two replies from two different slave devices, and each of the two different slave devices is associated with a different unique slave device identifier based on the order in which the replies are received.

13. The device of claim 1, wherein the processing circuit is further configured to:
add a slave device identifier, associated with the replying slave device, to a slave device list stored at a storage device.

14. The device of claim 13, wherein the slave device list includes a plurality of unique slave device identifiers and is indicative of a two dimensional arrangement of the plurality of slave devices.

15. The device of claim 13, wherein the slave device list includes a plurality of unique slave device identifiers and is indicative of an n-dimensional arrangement of the plurality of slave devices.

16. A method operational at a device, comprising:
sending a first broadcast over a shared bus to which a plurality of identical slave devices are coupled, the first broadcast initiating self-identification of one or more of the plurality of identical slave devices,
receiving a reply over the shared bus from a slave device, in response to the first broadcast, indicating that a slave device has self-identified, and
continuing to send one or more broadcasts over the shared bus, to uniquely identify each of the plurality of identical slave devices, until all slave devices in the plurality of identical slave devices have self-identified.

17. The method of claim 16, further comprising:
sending a communication over the shared bus specifically addressed to a first slave device using a corresponding first identifier, in the slave device list, associated with the first slave device.

18. The method of claim 16, wherein a unique slave device identifier for each of the plurality of identical slave devices is not explicitly provided to each slave device by the device.

19. The method of claim 16, wherein the device knows all slave devices have been identified when no reply is received to a broadcast over the shared bus.

20. The method of claim 16, wherein a unique slave device identifier for each slave device is not preconfigured into the slave devices.

21. The method of claim 16, wherein the reply implicitly indicates a unique identifier for the replying slave device but does not include the unique identifier.

22. The method of claim 16, wherein the processing circuit is further configured to:
control access to the bus shared by the plurality of identical slave devices.

23. A slave device, comprising:
a shared bus interface to couple to a shared bus;
a first interface and a second interface, distinct from the shared bus interface; and
a processing circuit coupled to the shared bus interface, the first interface, and the second interface, the processing circuit configured to:
receive a broadcast over a shared bus interface,
drive the first interface based on the broadcast and whether or not the slave device has a current identifier,
sense the second interface for a change of state from a default state,
ascertain, based on a state of the second interface and the slave device lacking a current identifier, that the slave device should self-identify,
associate a unique identifier, implied by the broadcast or discerned from information obtained from an adjacent slave device, with the slave device, and
reply to the broadcast over the shared bus with an acknowledgement.

24. The device of claim 23, wherein the first interface and second interface are single line interfaces to couple to one or more adjacent slave devices.

25. The device of claim 23, wherein the processing circuit is further configured to:
receive a communication over the shared bus specifically addressed to the unique identifier associated with the slave device.

26. The device of claim 23, wherein the unique identifier is not explicitly provided to the slave device.

27. The device of claim 23, wherein the unique identifier is not preconfigured into the slave device.

28. The device of claim 23, wherein the reply implicitly indicates the unique identifier.

29. The device of claim 23, wherein the processing circuit is further configured to:
receive one or more broadcasts over the shared bus; and
selectively drive or sense on the first interface and/or the second interface based on the one or more broadcasts and whether or not the slave device has a current identifier.

30. The device of claim 29, wherein each of the one or more broadcasts is distinct from each other and implies a unique identifier.

31. The device of claim 29, wherein each of the one or more broadcasts is the same and does not imply a unique identifier.

32. The device of claim 23, wherein a single broadcast results in two replies from two different slave devices, and each of the two different slave devices is associated with a different unique identifier based on the order in which the replies are received.

33. The device of claim 23, further comprising:
a third interface and a fourth interface, distinct from the shared bus, coupled to the processing circuit;
wherein the processing circuit is further configured to:
drive the third interface, distinct from the shared bus, based on the broadcast and whether or not the slave device has a current identifier,
sense a fourth interface for a change of state from the default state, and
further ascertain, based on a state of the fourth interface, that the reply should be sent over the shared bus.

34. A method operational at a slave device, comprising:
receiving a broadcast over a shared bus interface;
driving a first interface, distinct from the shared bus, based on the broadcast and whether or not the slave device has a current identifier;
sensing a second interface, distinct from the shared bus, for a change of state from a default state;
ascertaining, based on a state of the second interface and the slave device lacking a current identifier, that the slave device should self-identify;
associating a unique identifier, implied by broadcast or discerned from information obtained from an adjacent slave device, with the slave device; and
replying to the broadcast over the shared bus with an acknowledgement.

35. The method of claim 34, further comprising:
receiving a communication over the shared bus specifically addressed to the unique identifier associated with the slave device.

36. The method of claim 34, wherein the unique identifier is not explicitly provided to the slave device.

37. The method of claim 34, wherein the unique identifier is not preconfigured into the slave device.

38. The method of claim 34, wherein the reply implicitly indicates the unique identifier.

39. The method of claim 34, further comprising:
receiving one or more broadcasts over the shared bus;
selectively driving or sensing on the first interface and/or second interface based on the on the one or more broadcasts and whether or not the slave device has a current identifier.

40. The method of claim 34, further comprising:
driving a third interface, distinct from the shared bus, based on the broadcast and whether or not the slave device has a current identifier;
sensing a fourth interface for a change of state from the default state; and
ascertaining, based on a state of the fourth interface, that the reply should be sent over the shared bus.

41. A device, comprising:
a shared bus;
a master device coupled to the shared bus and configured to control communications over the shared bus;
a plurality of identical slave devices coupled to the shared bus, each slave device including a first interface and a second interface distinct from the shared bus, and each slave device is coupled to at least one other slave device over the first and/or second interface;
wherein the master device is configured to
uniquely identify each of the plurality of slave devices by
sending a first broadcast over the shared bus,
receiving a reply from a responding slave device indicating that a slave device has self-identified,
identify the responding slave device with a unique identifier, and
continuing to send additional broadcasts over the shared bus and receiving additional replies from different slave devices until all slave devices in the plurality of slave devices have self-identified.

42. The device of claim 41, wherein upon receipt of the first broadcast, each slave device is further configured to:
drive the first interface to cause the second interface of another slave device to be driven to a different state than its default state; and
sense the second interface to ascertain whether its default state has been changed by an adjacent slave device.

43. The device of claim 42, wherein only a first slave device whose second interface is not driven sends a reply over the shared bus.

44. The device of claim 43, wherein each additional slave device sends a reply in response to additional broadcasts on the shared bus depending on whether its second interface is driven or not, where slave devices that have already been identified drive or floats their first interface.
